(19) United States
(12) Patent Application Publication
(10) Pub. No.: US 2020/0395754 A1
(43) Pub. Date: Dec. 17, 2020

(54) SERIES POWER SUPPLY CIRCUITS

(71) Applicant: WHALECHAIN TECHNOLOGY INC., Taipei City (TW)

(72) Inventor: Chih-Hsin TSAI, Taipei City (TW)

(73) Assignee: WHALECHAIN TECHNOLOGY INC., Taipei City (TW)

(21) Appl. No.: 16/900,093

(22) Filed: Jun. 12, 2020

(30) Foreign Application Priority Data
Jun. 12, 2019 (TW) 108120684
Mar. 2, 2020 (TW) 109106696

(51) Int. Cl. H02J 1/14; H02M 3/158; H02J 9/06; H02M 1/32

(52) U.S. Cl. CPC H02J 1/14; H02M 1/32; H02J 9/061; H02M 3/1582

(57) ABSTRACT

The present disclosure provides a series power supply system, comprising a first DC power supply; a second DC power supply; a plurality of to-be-powered circuits connected to the first DC power supply in series, a first power for each of the to-be-powered circuits being supplied by the first DC power supply, a second power for each of the to-be-powered circuits being supplied by the second DC power supply; and a protection circuit respectively including a first terminal connected to the first DC power supply and a second terminal connected to the second DC power supply; wherein when the voltage difference between one or more of the to-be-powered circuits exceeds a threshold value, the protection circuit protects the plurality of to-be-powered circuits from burning.

### CROSS REFERENCE TO RELATED APPLICATION

This application claims the priority benefit of Taiwanese Patent Application Serial Number 108120684, filed on Jun. 12, 2019, and Taiwanese Patent Application Serial Number 109106696, filed on Mar. 2, 2020, the full disclosure of which is incorporated herein by reference.

### BACKGROUND

### Technical Field

This present disclosure relates to the technical field of power supply, in particular to the protection for series power supply circuits.

### Related Art

The mainstream design of electronic devices or systems currently on the market is to connect the to-be-powered circuit and the power circuit in parallel. In particular, when there are multiple to-be-powered circuits, the same power source may be used for parallel connection with the multiple circuits such that a particular to-be-powered circuit may be turned on or off without affecting other to-be-powered circuits.

For example, general indoor lighting fixtures are parallel circuits. It is assumed that when three lamps to be powered are connected in parallel to the same power supply circuit of the commercial power supply, a certain lamp can be turned on and off individually without affecting the other two lamps. However, if electrical appliances that consume a large amount of current are connected to the same power supply circuit, such as an electric oven or a hair dryer, when the electric oven and the hair dryer connected in parallel are turned on at the same time, the amount of current on the power supply circuit may exceed the load of the wire.

If a plurality of to-be-powered circuits are connected in series, and the voltage difference of the power supply is increased, the amount of current of the wire load can be reduced. However, when one of these to-be-powered circuits is turned off without warning, the voltage difference of the power supply for the other to-be-powered circuits would increase, resulting damage on the other to-be-powered circuits.

However, some applications require many to-be-powered circuits at the same time. For example, the application field of artificial intelligence requires a lot of computing chips, and the mining machine applied for virtual currency also needs a lot of computing chips. Therefore, it is desirous to develop a solution to solve the problem of burning or failure of other components on the series circuit arising from a sudden failure of a to-be-powered circuit for the situation that a plurality of to-be-powered circuits are connected in series.

### SUMMARY

According to one embodiment of the present disclosure, a series power supply system is provided. The series power supply system comprises a first DC power supply; a second DC power supply; a plurality of to-be-powered circuits connected to the first DC power supply in series, a first power for each of the to-be-powered circuits being supplied by the first DC power supply, a second power for each of the to-be-powered circuits being supplied by the second DC power supply; and a protection circuit respectively including a first terminal connected to the first DC power supply and a second terminal connected to the second DC power supply; wherein when the voltage difference between one or more of the to-be-powered circuits exceeds a threshold value, the protection circuit is used to protect the plurality of to-be-powered circuits from burning.

In one embodiment of the present disclosure, a series power supply system is provided, comprising: a plurality of to-be-powered circuits connected to a first DC power supply in series, a first power for each of the to-be-powered circuits being supplied by the first DC power supply, a second power for each of the to-be-powered circuits being supplied by a second DC power supply; and a protection circuit comprising a first terminal and a second terminal, wherein the first terminal is connected to the first power of the Xth to-be-powered circuit, and the second terminal is connected to the second power of the Yth to-be-powered circuit; when the voltage difference between the first terminal and the second terminal exceeds a threshold value, the protection circuit is used to protect the plurality of to-be-powered circuits from burning; wherein X and Y are positive integers.

In summary, the series power supply system provided by the present disclosure has a protection circuit, which can protect the remaining to-be-powered circuits when one of the to-be-powered circuits suddenly fails, so as to avoid burning the rest of the to-be-powered circuits.

In another embodiment, a power supply system for a multi-stage series circuit is provided, comprising a power supply, a dynamic voltage sensing unit and a protection circuit. The power supply provides a power voltage to the multi-stage series circuit. The dynamic voltage sensing unit comprises a protection voltage level generator, a comparator, and a latch. The protection voltage level generator receives a reference voltage and generates a protection voltage according to the reference voltage. The comparator receives the protection voltage and the power voltage provided to the multi-stage series circuit, and compares the protection voltage and the power voltage to output a comparison voltage. The protection circuit activates in response to the comparison voltage.

In another embodiment, a power supply system for a multi-stage series circuit is provided, comprising a power supply, a dynamic voltage sensing unit and a protection circuit. The power supply provides a power voltage to the multi-stage series circuit. The dynamic voltage sensing unit comprises a protection voltage level generator, a comparator, and a latch. The protection voltage level generator receives the power voltage and generates a protection voltage according to the power voltage. The comparator receives the protection voltage and a monitoring voltage of the multi-stage series circuit, and compares the protection voltage and the monitoring voltage to output a comparison voltage. The protection circuit activates in response to the comparison voltage.

The power supply system for a multi-stage series circuit disclosed in the present disclosure outputs a protection voltage according to the preset power voltage of the chips or the monitoring voltage of the chips through the dynamic voltage sensing unit, so that the dynamic voltage sensing unit may determine whether to activate the protection circuit according to the power voltage of the chips or the monitoring voltage of the chips. The problem of high noise, voltage instability, overvoltage and easy burnout arisen from the many chips connected in series may be solved.

In addition, a voltage balancing unit or a circuit required to balance the supply voltage are additionally configured for the chips of the prior art. Those circuits are not required for the power supply system for a multi-stage series circuit of the present disclosure, which can reduce the design cost and the circuit complexity.

It should be understood, however, that this summary may not contain all aspects and embodiments of the present disclosure, that this summary is not meant to be limiting or restrictive in any manner, and that the present disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1A is a block diagram of a series power supply system according to one embodiment of the disclosure;

FIG. 1B is a block diagram of a series power supply system according to one embodiment of the disclosure;

FIG. 2A is a block diagram of a series power supply system according to one embodiment of the disclosure;

FIG. 2B is a block diagram of a series power supply system according to one embodiment of the disclosure;

FIG. 2C is a block diagram of a series power supply system according to one embodiment of the disclosure;

FIG. 3A is a schematic circuit diagram of a protection circuit according to one embodiment of the disclosure;

FIG. 3B is a schematic circuit diagram of a protection circuit according to one embodiment of the disclosure;

FIG. 4A is a block diagram of a series power supply system according to one embodiment of the disclosure;

FIG. 4B is a block diagram of a series power supply system according to one embodiment of the disclosure;

FIG. 4C is a block diagram of a series power supply system according to one embodiment of the disclosure;

FIG. 5A is a schematic circuit diagram of a protection circuit according to one embodiment of the disclosure;

FIG. 5B is a schematic circuit diagram of a protection circuit according to one embodiment of the disclosure;

FIG. 6A is a schematic diagram of a series power supply system according to one embodiment of the disclosure;

FIG. 6B is a schematic diagram of a series power supply system according to another embodiment of the disclosure;

FIG. 7 is a schematic circuit diagram of a protection circuit according to one embodiment of the disclosure;

FIG. 8A is a schematic diagram of a series power supply system according to one embodiment of the disclosure;

FIG. 8B is a schematic diagram of a series power supply system according to one embodiment of the disclosure;

FIG. 8C is a schematic diagram of a series power supply system according to one embodiment of the disclosure;

FIG. 8D is a schematic diagram of a series power supply system according to one embodiment of the disclosure;

FIG. 8E is a schematic diagram of a series power supply system according to one embodiment of the disclosure;

FIG. 9A is a schematic diagram of a series power supply system according to one embodiment of the disclosure;

FIG. 9B is a schematic diagram of a series power supply system according to one embodiment of the disclosure;

FIG. 9C is a schematic diagram of a series power supply system according to one embodiment of the disclosure;

FIG. 10A is a schematic diagram of a series power supply system according to one embodiment of the disclosure;

FIG. 10B is a schematic diagram of a series power supply system according to one embodiment of the disclosure;

FIG. 10C is a schematic diagram of a series power supply system according to one embodiment of the disclosure;

FIG. 10D is a schematic diagram of a series power supply system according to one embodiment of the disclosure;

FIG. 11 is a circuit diagram of a power supply system for a multi-stage series circuit according to one embodiment of the present disclosure.

FIG. 12 is a circuit diagram of a power supply system for a multi-stage series circuit according to another embodiment of the present disclosure.

FIG. 13 is a circuit diagram of a power supply system for a multi-stage series circuit according to another embodiment of the present disclosure.

FIG. 14 is a circuit diagram of a power supply system for a multi-stage series circuit according to another embodiment of the present disclosure.

### DETAILED DESCRIPTION OF THE EMBODIMENTS

The present disclosure will now be described more fully hereinafter with reference to the accompanying drawings, in which exemplary embodiments of the present disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the present disclosure. This description is made for the purpose of illustration of the general principles of the present disclosure and should not be taken in a limiting sense. The scope of the present disclosure is best determined by reference to the appended claims.

Moreover, the terms “include”, “contain”, and any variation thereof are intended to cover a non-exclusive inclusion. Therefore, a process, method, object, or device that comprises a series of elements not only include these elements, but also comprises other elements not specified expressly, or may include inherent elements of the process, method, object, or device. If no more limitations are made, an element limited by “include a/an” does not exclude other same elements existing in the process, the method, the article, or the device which comprises the element.

In the following embodiment, the same reference numerals are used to refer to the same or similar elements throughout the present disclosure.

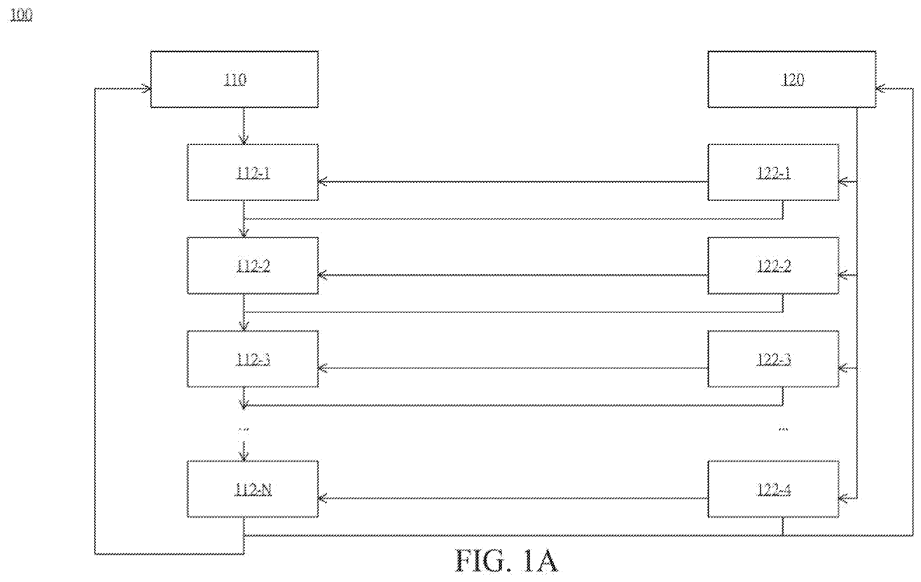

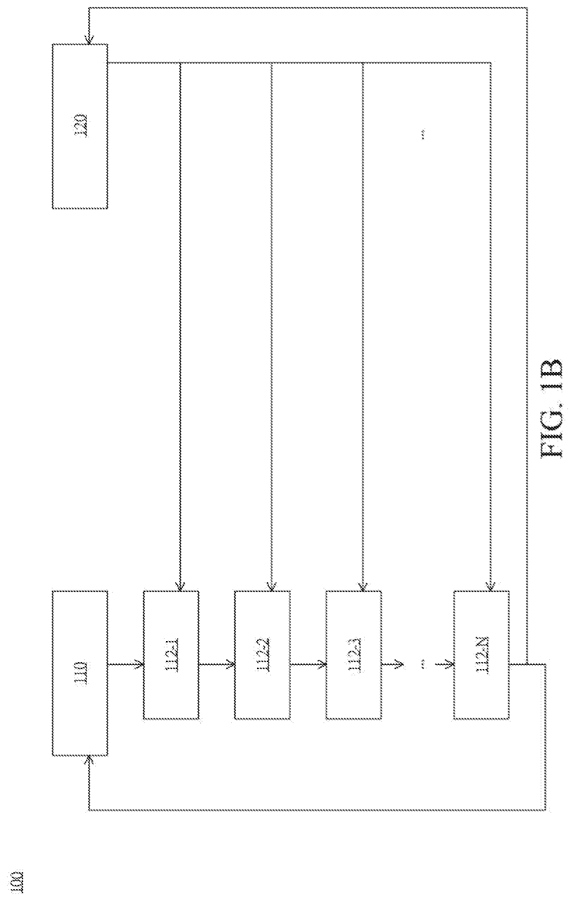

FIG. 1A is a block diagram of a series power supply system according to one embodiment of the disclosure. The series power supply system 100 may be implemented on one or more circuit boards. In some embodiments, the series power supply system 100 may be a mining machine system for a virtual currency system, an artificial intelligence computer system, or a computer system using a large number of circuits of the same type.

The series power supply system 100 includes a first direct current (DC) power supply 110 and a second DC power supply 120. The first DC power supply 110 includes a buck converter, which is a DC-DC converter for lowering the voltage. The voltage at the output end is lower than the voltage at the input end, but the output current is greater than the input current. Similarly, the second DC power supply 120 also includes a buck converter. For example, the voltage of the input terminal of the first DC power supply 110 may be 48V, 24V, 12V or 5V, which is common for computer systems, but the voltage of the output terminal may be lowered to 5V, 3.3V, 1.5V, 0.9V or 0.7V, which is common for integrated circuit devices. Similarly, the second DC power supply 120 may also have one of the above specifications.

In one embodiment, the series power supply system 100 includes a plurality of to-be-powered circuits 112 connected in series. As shown in FIG. 1A to 1B, there are N to-be-powered circuits 112-1 to 112-N, wherein N is a positive integer greater than one. As mentioned above, the to-be-powered circuits 112 may be chips used for arithmetic and logic operations, such as calculation chips in the field of artificial intelligence, or mining chips for virtual currency. For example, the to-be-powered circuits 112 may include general arithmetic and logic operation units, or may include general arithmetic and logic operation unit arrays. In addition to the general arithmetic and logic operation units, the to-be-powered circuit 112 may also include an operation circuit suitable for a specific application scenario. In addition, the to-be-powered circuit 112 includes an interface for input and output, so as to input data required by the arithmetic circuit or the arithmetic unit, and output the result obtained after the operation.

In one embodiment, each to-be-powered circuit 112 may be an independently packaged integrated circuit. In another embodiment, each to-be-powered circuit 112 may be a single chip, and a plurality of to-be-powered circuits 112 may be packaged in a package by an interposer or a substrate. In another embodiment, each to-be-powered circuit 112 may be implemented on an independent area on a chip, and the plurality of to-be-powered circuits 112 can be combined together by wiring inside the chip. The present disclosure does not limit whether the plurality of to-be-powered circuits 112 are on the same circuit board, or whether the plurality of power supply circuits 112 are in the same package, or even whether the plurality of to-be-powered circuits 112 are in the same chip.

In one embodiment of the present disclosure, the configuration of each to-be-powered circuit 112 is the same. For example, each to-be-powered circuit 112 may be an integrated circuit of the same model. Under the same operation mode, the power consumed by each to-be-powered circuit 112 is equivalent. In other words, in the embodiment shown in FIG. 1A, the voltage difference between the input voltage and the output voltage of the to-be-powered circuit 112-1 is almost equal to the voltage difference between the input voltage and the output voltage of the other to-be-powered circuits 112-i, wherein “i” is a positive integer from 2 to N. However, the present disclosure does not limit all the to-be-powered circuits 112 to have the same operation mode, nor does it limit that all the to-be-powered circuits 112 have the same power consumption during operation.

The to-be-powered circuit 112 has two or more power supply mode. For example, the arithmetic and logic operation unit inside the to-be-powered circuit 112 uses a power supply mode of 0.9V, and the output unit inside the to-be-powered circuit 112 uses a power supply mode of 3.3V. Higher voltage is used to drive the output signal. In some examples, the circuit to be powered 112 may include two kinds of input and output interfaces, each requiring a different voltage. Therefore, the to-be-powered circuit 112 needs to have three power supply more.

Generally speaking, the arithmetic and logic operation unit inside the to-be-powered circuit 112 uses a power supply mode with a lower voltage to save power. However, the input and output interface of the to-be-powered circuit 112 uses a power supply mode with a higher voltage to improve the noise ratio and reduce the communication error rate. However, the present disclosure does not limit the input and output interface to use the power supply mode with the higher voltage.

In the embodiment shown in FIG. 1A, the second DC power supply 120 supplies power to the multiple power supplies 122. Each power supply 122 corresponds to one to-be-powered circuit 112. For example, the power supply 122-i corresponds to the to-be-powered circuit 112-i, wherein “i” is a positive integer from 2 to N. As for a certain to-be-powered circuit 112, the 0.9V supplied for the internal arithmetic and logic operation unit is from the voltage difference from the output of the former to-be-powered circuit 112 and the input of the latter to-be-powered circuit 112. The 3.3V supplied for the internal output unit is from the voltage difference between the corresponding power supply 122 and the input of the latter to-be-powered circuit 112. For the first to-be-powered circuit 112-1, the internal arithmetic and logic operation unit uses a 0.9V power supply mode from the voltage difference between the output of the first DC power supply 110 and the input of the second to-be-powered circuit 112-2. The 3.3V supplied for the internal output unit is from the voltage difference between the corresponding power supply 122-1 and the input terminal of the second circuit to be powered 112-2.

In one embodiment, the power supply 122 may include a linear DC regulator and/or a low dropout regulator (LDO). The present disclosure does not limit the types of voltage regulators included in the power supply 122.

In the embodiment shown in FIG. 1A, when one or more of the to-be-powered circuits 112 suddenly fail or close without warning, the voltage difference distributed to other to-be-powered circuits 112 would become larger, which may cause the to-be-powered circuits 112 burned. In addition, the power supply 122 corresponding to the failed or closed to-be-powered circuit 112 still continues to supply power. Therefore it may also cause the to-be-powered circuit 112 before the failed or closed to-be-powered circuit 112 to be burned by the reverse voltage shock. In order to avoid the above problems, this present disclosure proposes a solution.

FIG. 1B is a block diagram of a series power supply system according to one embodiment of the disclosure. The difference between the embodiment shown in FIG. 1B and the embodiment shown in FIG. 1A is that the second power 120 can directly supply power to each to-be-powered circuit 112. In other words, the to-be-powered circuit 112 may be connected in series or in parallel. When the to-be-powered circuit 112 connected in series fails, resulting in an excessively large voltage difference, this is also a situation that can be avoided by the solution provided by the present disclosure.

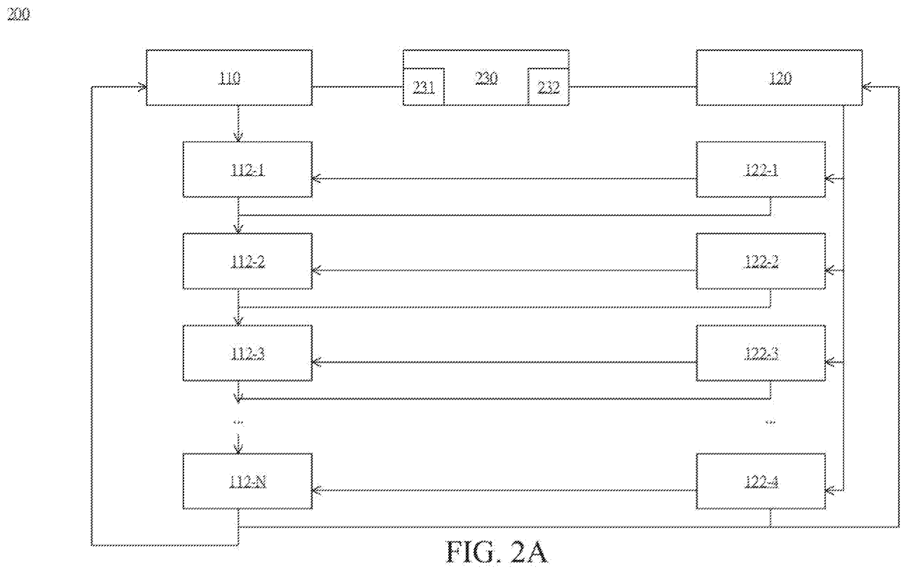

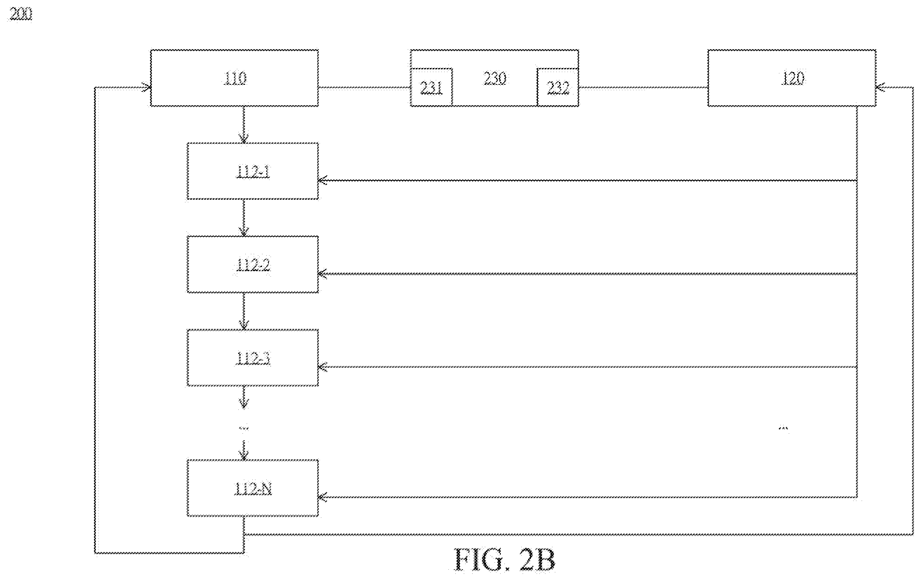

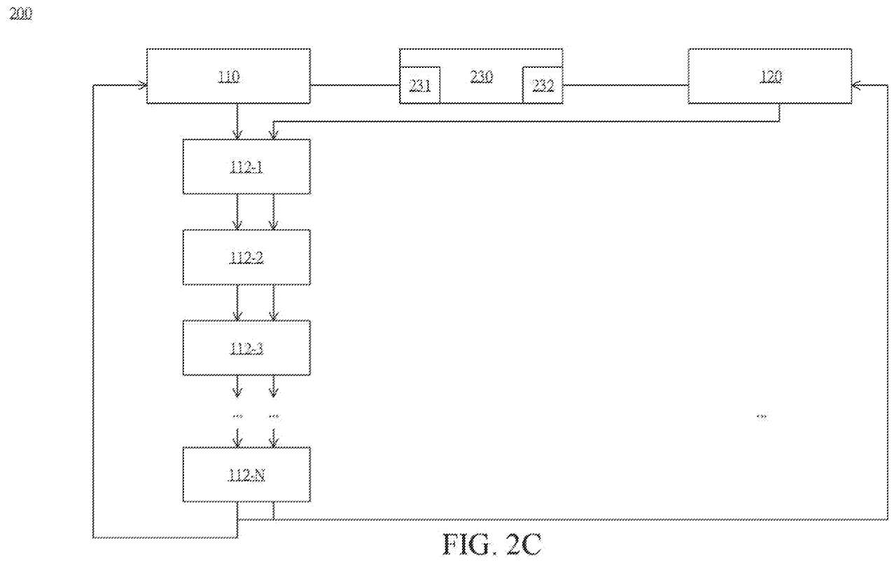

FIG. 2A is a block diagram of a series power supply system according to another embodiment of the disclosure. The difference between the series power supply system 200 and the series power supply system 100 shown in FIG. 1A is that this embodiment further incorporates a protection circuit 230. The protection circuit 230 includes a first terminal 231 and a second terminal 232, which are respectively connected to the output of the first DC power supply 110 and the output of the second DC power supply 120. The output voltage of the second DC power supply 120 is usually greater than the output voltage of the first DC power supply 110.

FIG. 2B is a block diagram of a series power supply system according to another embodiment of the disclosure. The difference between the series power supply system 200 and the series power supply system 100 shown in FIG. 1B is that this embodiment further incorporates a protection circuit 230. The protection circuit 230 includes a first terminal 231 and a second terminal 232, which are respectively connected the output of the first DC power supply 110 and the output of the second DC power supply 120. The output voltage of the second DC power supply 120 is usually greater than the output voltage of the first DC power supply 110.

FIG. 2C is a block diagram of a series power supply system according to another embodiment of the disclosure. Compared with the embodiment shown in FIG. 2B, after the first to-be-powered circuit 112-1 receives the second power from the second DC power supply 120, its output terminal is connected to the second power of the second to-be-powered circuit 112-2. The third to-be-powered circuit 112-3 receives the second power from the second power output of the second to-be-powered circuit 112-2. And so on, until the second power output of the last to-be-powered circuit 112-N shares the ground with the first power output, the second power output is connected back to the second DC power supply 120.

In the embodiment shown in FIG. 2C, each to-be-powered circuit 112 has two power supply modes. In the series power supply system 200, there are two power supply modes, powered by the first DC power supply 110 and the second DC power supply 120 respectively. When one of the two power supply modes of one to-be-powered circuit 112 suddenly fails, resulting in an excessively large voltage difference, the protection circuit 230 will function.

Although the to-be-powered circuit 112 shown in the embodiment of FIGS. 2A to 2C has only two power supply modes, those of ordinary skill in the art may understand that each to-be-powered circuit 112 may have more than two power supply modes. The voltage of each power supply mode may be the same or different.

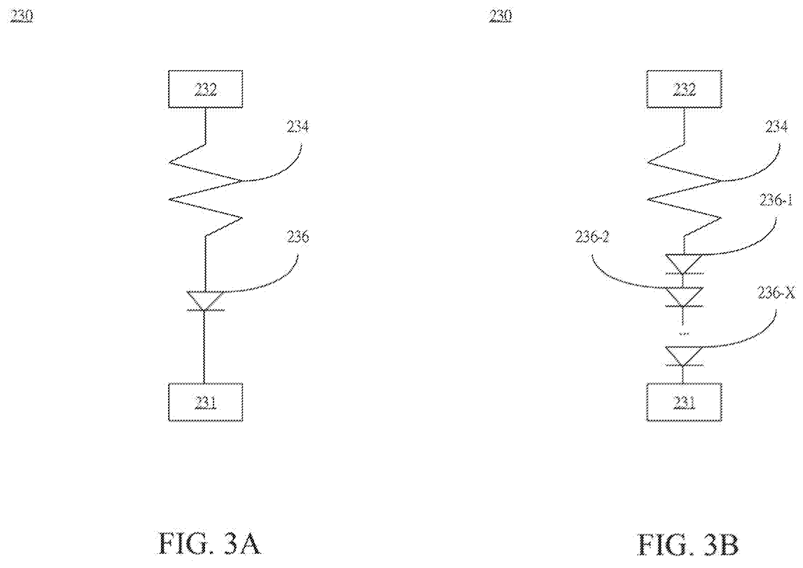

FIG. 3A is a schematic circuit diagram of a protection circuit according to one embodiment of the disclosure. The protection circuit 230 includes a damping diode 236 connected to the first terminal 231 and a resistor 234 connected to the damping diode 236 and the second terminal 232. The anode of the damping diode 236 is connected to the resistor 234, and the cathode of the damping diode 236 is connected to the first terminal 231. The resistance of the resistor 234 is set to correspond to the voltage difference between the first terminal 231 and the second terminal 232.

When one or more to-be-powered circuits 112 of the series power supply system 200 shown in FIGS. 2A and 2B suddenly fail or close without warning, the voltage difference raised by the output circuit of the first DC power supply 110 would be absorbed by the damping diode 236 so that the voltage fluctuation of the other to-be-powered circuits 112 is more stable, and the other to-be-powered circuits 112 would not be burned due to the instantaneous voltage change.

FIG. 3B is a schematic circuit diagram of a protection circuit according to another embodiment of the disclosure. Compared with the embodiment shown in FIG. 3A, the protection circuit 230 shown in FIG. 3B has a plurality of damping diodes 236 connected in series. The anode of the first damping diode 236 is connected to the resistor 234, and the cathode of the last damping diode 236 is connected to the first terminal 231. The anode of the damping diode 236 is connected to the cathode of the previous damping diode. When the coefficient of a single damping diode 236 is insufficient to meet the demand, multiple damping diodes 236 can be connected in series.

In a variation of FIG. 3A, the order of connecting the damping diode 236 and the resistor 234 may be switched. In a variation of FIG. 3B, the connection order of the plurality of damping diodes 236-1˜236-X and the resistor 234 can be switched. In a variation of FIG. 3A, the protection circuit 230 may include only one or more damping diodes 236. In a variation of FIG. 3A, the protection circuit 230 may include only one or more resistors 234. The present disclosure does not limit the type of the number of resistors or diodes included in the protection circuit 230, nor does it limit the components constituting the protection circuit 230. Any kind of protection circuit 230 that may protect the to-be-powered circuit 112 from burning due to excess voltage difference may be used to implement the embodiment.

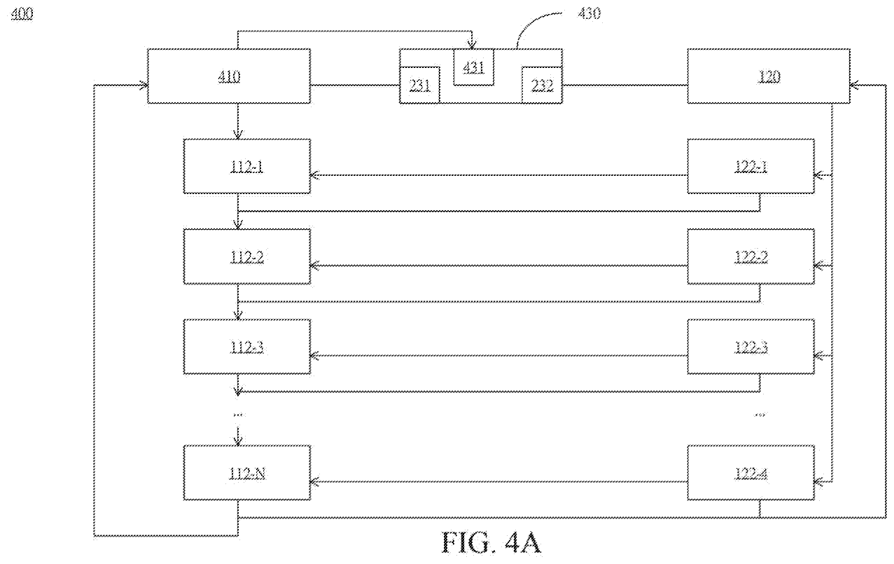

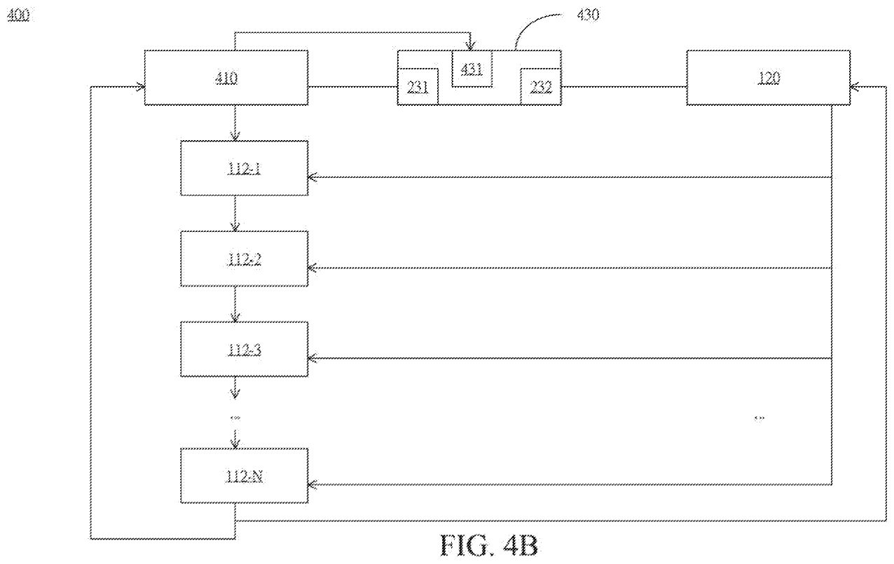

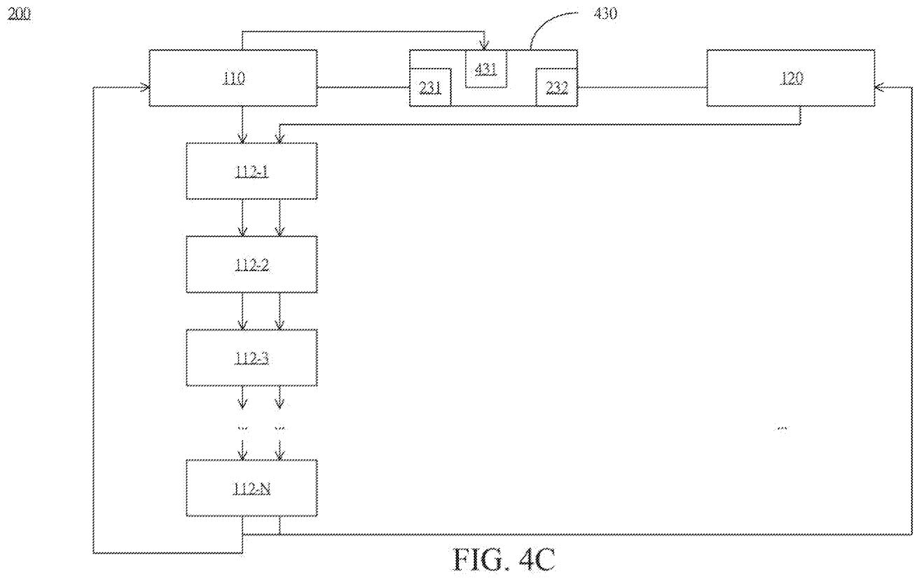

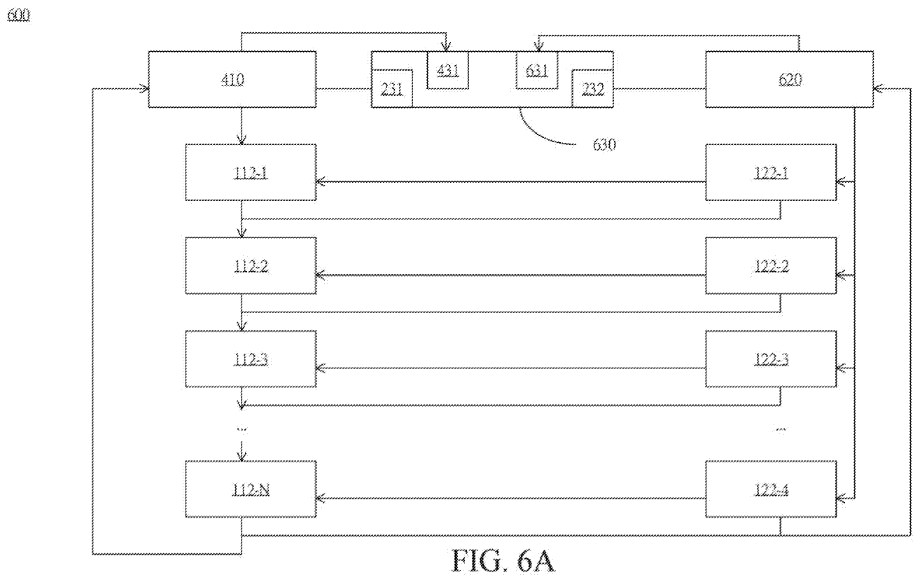

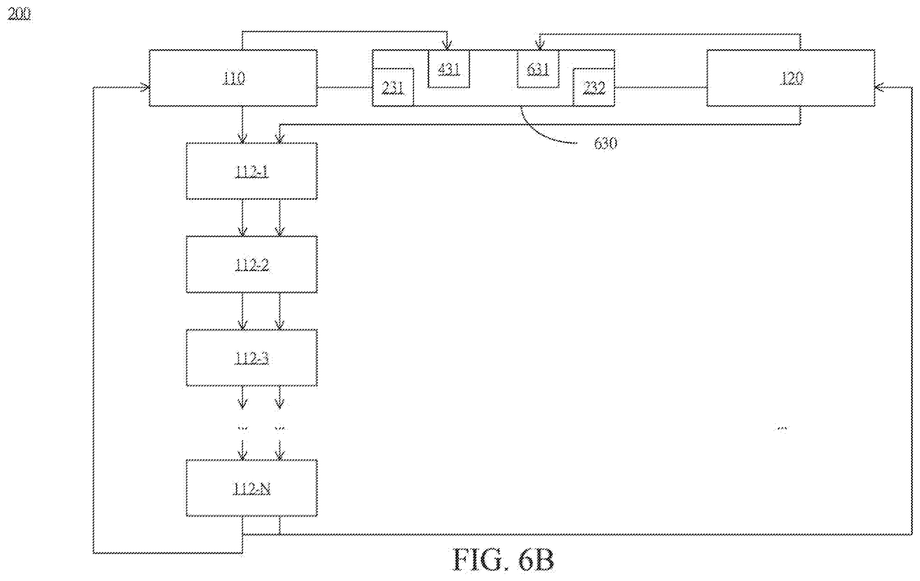

Although the protection circuit 230 shown in FIGS. 3A and 3B can protect the to-be-powered circuits 112, the resistor 234 of the protection circuit 230 continues to consume power. In order to solve this problem, the embodiments shown in FIG. 4A, FIG. 4B or FIGS. 6A and 6B adopts a switch circuit to determine whether to turn on the protection circuit or not.

FIG. 4A is a block diagram of a series power supply system according to one embodiment of the disclosure. Compared with the series power supply system 200 shown in FIG. 2A, the protection circuit 430 of FIG. 4A is different from the protection circuit 230, and the first DC power supply 410 of FIG. 4A is also different from the first DC power supply 110.

The first DC power supply 410 includes a detection circuit and a corresponding output. In one embodiment, the detection circuit is used to detect whether the power output by the first DC power supply 410 is momentarily reduced. When the output power decreases instantaneously, it means that one or more of the to-be-powered circuits 112 suddenly fails or closes without warning. In another embodiment, the detection circuit may be used to detect whether the voltage and/or current output by the first DC power supply 410 is abnormal. When an abnormal condition is detected, the first DC power supply 410 generates an output signal to a switch port 431 of the protection circuit 430. When the switch port 431 receives the output signal indicating that the power is instantaneously reduced, the protection circuit 430 is turned on to prevent other to-be-powered circuits 112 from burning down.

This application does not limit that the detection circuit is used to detect whether the voltage, current, and power values are abnormal. As long as the detection circuit can detect that at least one of the above three values or any combination thereof is abnormal, the protection circuit 430 is turned on.

In an embodiment, the detection circuit and its corresponding output signal line may be integrated with the first DC power supply 410 in the same integrated circuit. In another embodiment, the detection circuit and its corresponding output signal circuit may be implemented outside the integrated circuit of the first DC power supply 410. For example, the detection circuit and its corresponding output signal circuit may be a common power monitoring integrated circuit on the market for detecting the output power of the first DC power supply 410. In other embodiments, a power control integrated circuit may also be used, which contains a programmable embedded processor to achieve the above-mentioned functions. The present disclosure does not limit whether the detection circuit and the power supply circuit should be implemented together. Only one detection circuit is needed to turn on and off the protection circuit 430.

FIG. 4B is a block diagram of a series power supply system according to one embodiment of the disclosure. Compared with the series power supply system 200 shown in FIG. 2B, the protection circuit 430 of FIG. 4B is different from the protection circuit 230, and the first DC power supply 410 of FIG. 4B is also different from the first DC power supply 110. The difference is already mentioned in the description for FIG. 4A and is not be repeated here.

FIG. 4C is a block diagram of a series power supply system according to one embodiment of the disclosure. Compared with the series power supply system 200 shown in FIG. 2C, the protection circuit 430 of FIG. 4C is different from the protection circuit 230, and the first DC power supply 410 of FIG. 4C is also different from the first DC power supply 110. The difference is already mentioned in the description for FIG. 4A and will not be repeated here.

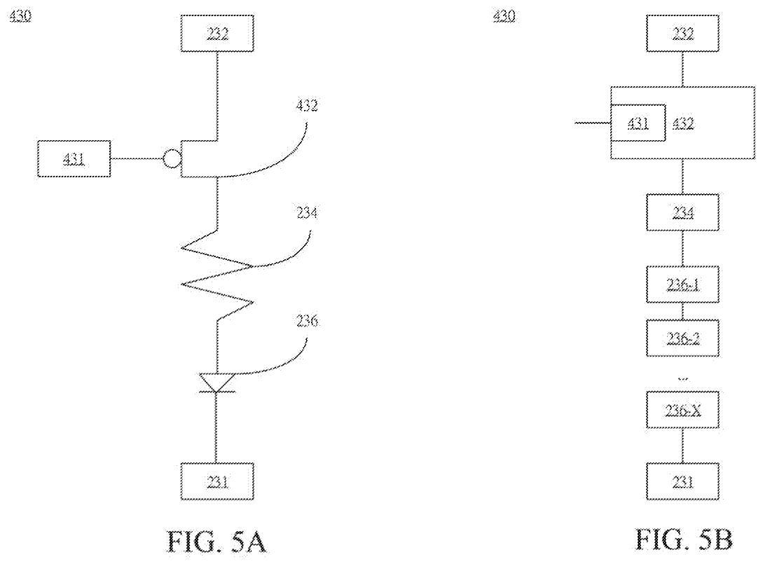

FIG. 5A and FIG. 5B are schematic circuit diagrams of a protection circuit according to another embodiment of the disclosure. The protection circuit 430 shown in FIG. 5A is a variation of the protection circuit 230 shown in FIG. 3A. In another embodiment shown in FIG. 5B, the protection circuit 430 is also a variation of the protection circuit 230 shown in FIG. 3B.

In addition to the existing components of the protection circuit 230, the protection circuit 430 includes a switch port 431 to receive the detection signal and an electronic switch element 432 for connecting the second terminal 232 and the resistor 234 and the switch port 431. After the switch port 431 receives the detection signal, the electronic switch element 432 turns on the second terminal 232 and the resistor 234 so that the protection circuit 430 can protect the to-be-powered circuit 112. In the normal state, the resistor 234 does not consume power.

Persons with ordinary skills in the related art may understand that the embodiments shown in FIGS. 5A and 5B are merely exemplary. Among other possible variations, the electronic switch element 432 may be connected to any position among the first terminal 231, the damping diode 236, the resistor 234, and the second terminal 232. The electronic switch element 432 may be an electronic switch composed of various transistors or a combination thereof, and may be adapted to input signals received by various switch ports 431. For example, the input signal may be upper edge start, lower edge start, high start, low start, etc. The electronic switch element 432 can be designed and changed according to the type of the input signal.

The electronic switch element 432 may be an N-type metal oxide semiconductor field effect transistor (NMOS) shown in FIG. 5A, or may also be other types of transistors or electronic switches. In the embodiment shown in FIG. 5B, the electronic switch element 432 is drawn in an abstract manner, which is used to indicate that the electronic switch element 432 may be other types of components or a combination thereof. In the description of FIGS. 3A and 3B, various changes of the protection circuit 230 are also mentioned. The embodiments of FIGS. 5A and 5B are also applicable to the above variations. The electronic switch element 432 can be connected to any position among the first terminal 231 and the second terminal 232.

In the embodiments of FIG. 1A, FIG. 2 and FIG. 4A, the power supply 122 may suddenly fail or shut down without warning, which may also cause other power supply 122 to burn out. Therefore, the above embodiments can be applied to solve similar problems.

FIG. 6A is a block diagram of a series power supply system according to one embodiment of the disclosure. Compared with the series power supply system 400 shown in FIG. 4A, the protection circuit 630 of FIG. 6A is different from the protection circuit 430, and the second DC power supply 620 of FIG. 6A is also different from the second DC power supply 420.

The second DC power supply 620 includes another detection circuit and corresponding output. In one embodiment, the detection circuit is used to detect whether the power output by the second DC power supply 610 is momentarily reduced. When the output power decreases instantaneously, it means that one or more power supplies 122 suddenly fail or shut down without warning. In another embodiment, the detection circuit may be used to detect whether the voltage and/or current output by the first DC power supply 410 is abnormal. When detecting an abnormal situation, the second DC power supply 620 outputs an output signal to the switch port 631 of the protection circuit 630. When the switch port 631 receives the output signal indicating that the power is instantaneously reduced, the protection circuit 630 is turned on to prevent the other power supply 122 from burning.

Similar to the example of the first DC power supply 410, in one embodiment, the detection circuit and its corresponding output signal line may be integrated with the second DC power supply 620 in the same integrated circuit. In another embodiment, the detection circuit and its corresponding output signal line may be implemented outside the integrated circuit of the second DC power supply 620. For example, the detection circuit and its corresponding output signal circuit may be a common power monitoring integrated circuit on the market for detecting the output power of the second DC power supply 620. In other embodiments, a power control integrated circuit may also be used, which contains a programmable embedded processor to achieve the above-mentioned functions. The present disclosure does not limit whether the detection circuit and the power supply circuit should be implemented together. Only one detection circuit is needed to turn on and off the protection circuit 630.

This present disclsoure does not limit that the detection circuit is used to detect whether the voltage, current, and power values are abnormal. As long as the detection circuit can detect that at least one of the above three values or any combination thereof is abnormal, the protection circuit 630 is turned on.

FIG. 6B is a block diagram of a series power supply system according to one embodiment of the disclosure. Compared with the series power supply system 400 shown in FIG. 4C, the protection circuit 630 of FIG. 6B is different from the protection circuit 430, and the second DC power supply 620 of FIG. 6B is also different from the second DC power supply 420. The remaining parts of FIG. 6B are the same as those in the embodiment shown in FIG. 6A.

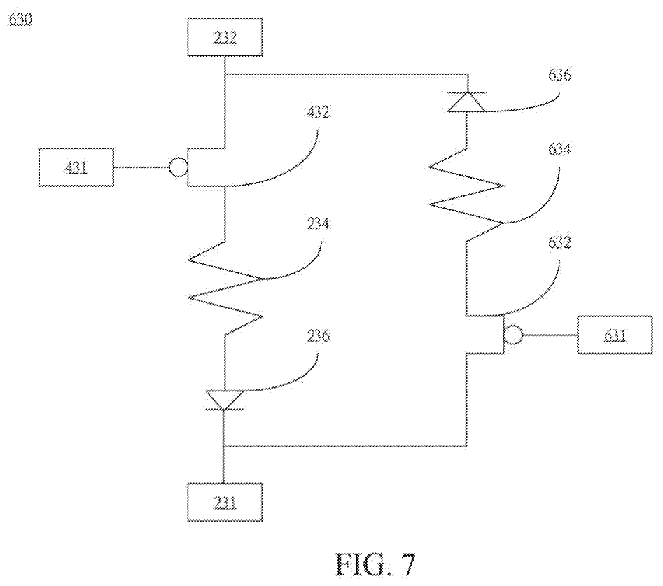

Refer to FIG. 7, which is a schematic circuit diagram of a protection circuit 630 according to one embodiment of the present disclosure. The protection circuit 630 is a variation of the protection circuit 430 shown in FIG. 5A. In another embodiment, the protection circuit 630 is also a variation of the protection circuit 430 shown in FIG. 5B.

Compared to the protection circuit 430, the protection circuit 630 shown in FIG. 7 includes two protection circuits connected in parallel, respectively connected to the first terminal 231 and the second terminal 232. The protection circuit on the left of the figure is generally as shown in the embodiment shown in FIG. 5A, and is not be repeated here. The protection circuit on the right of the figure is just opposite to the protection circuit on the left, and is used to protect the power supply 122 from burning.

A second electronic switch element 632 is connected to the second switch port 631, the first terminal 231, and a second resistor 634, respectively. The second switch port 631 receives the output signal of the second DC power supply 620. The protection circuit 630 further includes a second damping diode 636 whose cathode is connected to the second terminal 232 and whose anode is connected to the second resistor 634. After the second switch port 631 receives the detection signal, the second electronic switch element 632 turns on and the first terminal 231 and the second resistor 634 are electrically connected accordingly, so that the protection circuit 630 can protect the power supply 122. In the normal state, the resistor 634 does not consume power.

Those with ordinary skills in the related art may understand that the embodiment shown in FIG. 7 is only an example. Among other possible variations, the second electronic switch element 632 may be connected to any position among the first terminal 231, the second resistor 634, the second damping diode 636, and the second terminal 232. The second electronic switch element 632 may be an electronic switch composed of various transistors or a combination thereof, and may be adapted to input signals received by various switch ports 631. For example, the input signal may be upper edge start, lower edge start, high start, low start, etc. The second electronic switch element 632 can be designed and changed according to the type of the input signal.

Since the impedance values of the to-be-powered circuit 112 and the power supply 122 are different, the impedance values of the resistor 234 and the second resistor 634 in FIG. 7 may be different. Similar to the embodiment shown in FIG. 5B, the protection circuits connected in parallel in the protection circuit 630 may respectively include a plurality of damping diodes. The protection circuit 630 shown in FIG. 7 can be applied to various variations of the protection circuits 230 and 430 shown in FIG. 3A, FIG. 3B, FIG. 5A and FIG. 5B.

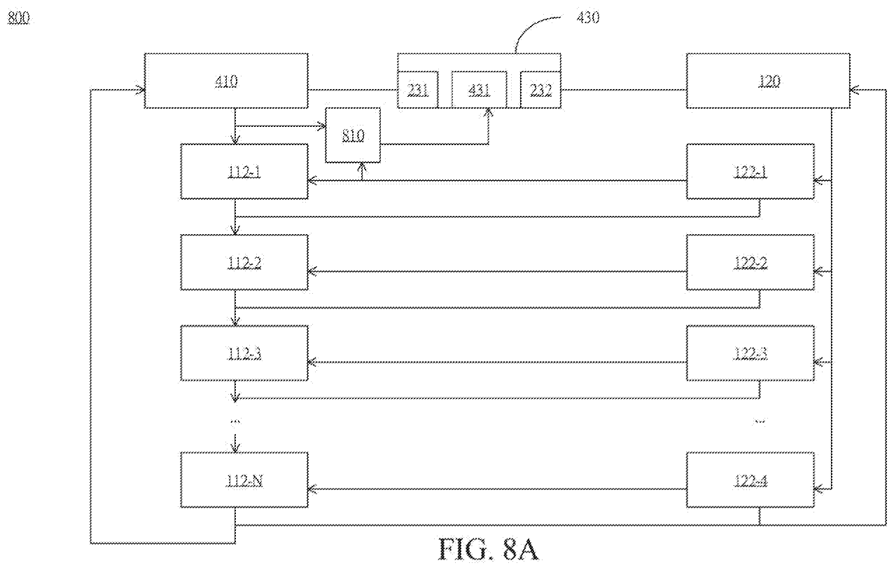

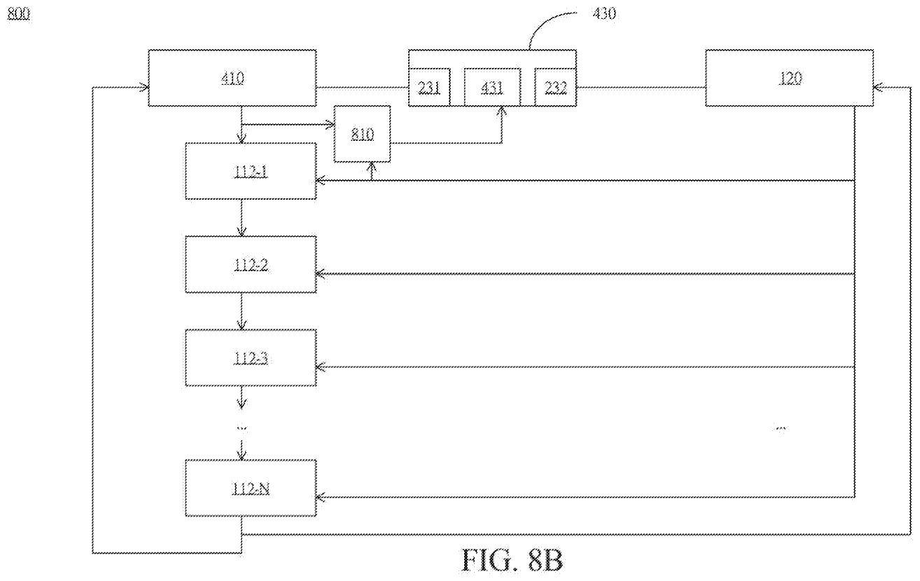

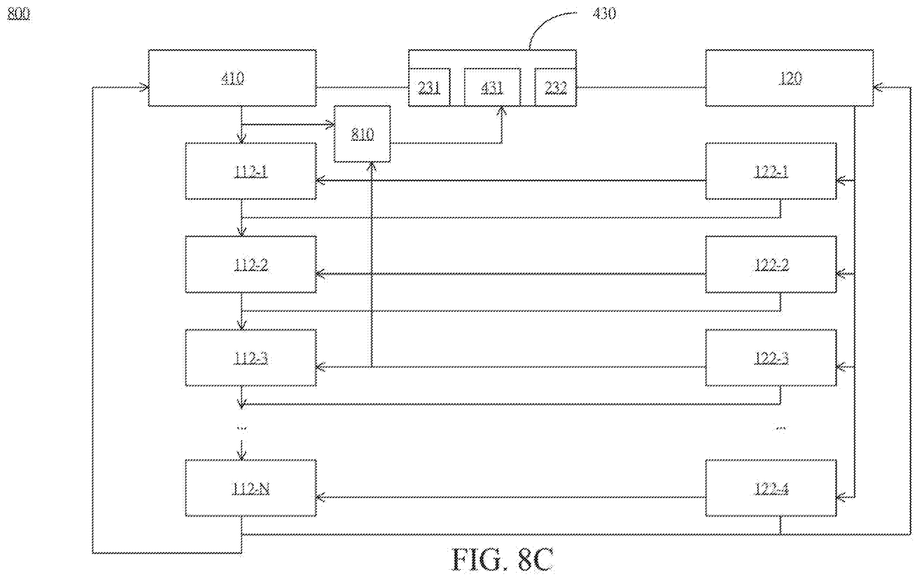

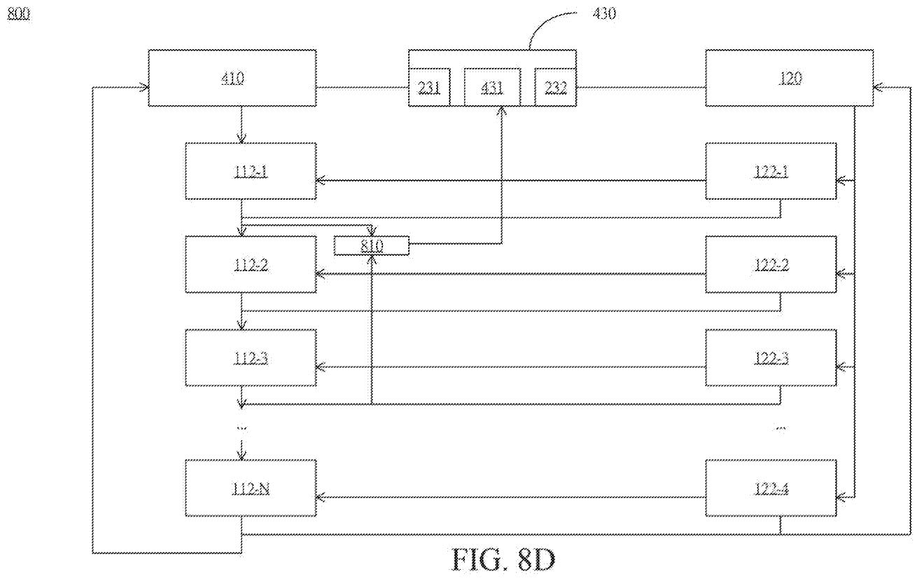

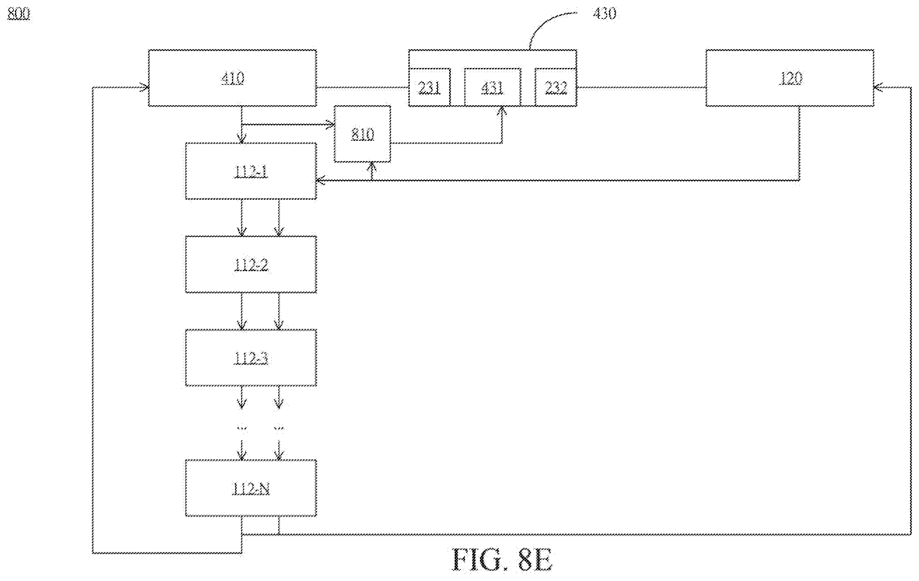

FIG. 8A is a schematic diagram of a series power supply system according to one embodiment of the disclosure. Compared with the series power supply system 400 shown in FIG. 4A, the series power supply system 800 includes a detection circuit 810 for detecting the voltage difference between the two input terminals of the first to-be-powered circuit 112-1. When the voltage difference between the two input terminals is greater than a certain value, the detection circuit 810 outputs a signal to the switch port 431 of the protection circuit 430. When the switch port 431 receives an output signal indicating that the voltage difference exceeds a threshold value, the protection circuit 430 is turned on to prevent the to-be-powered circuit 112-1 from burning. Persons of ordinary skills in the related art may understand that the detection circuit 810 may include a common comparator or an equivalent circuit of the comparator for detecting the voltage difference between the two input terminals of the first to-be-powered circuit 112-1.

FIG. 8B is a schematic diagram of a series power supply system according to one embodiment of the disclosure. Compared with the series power supply system 400 shown in FIG. 4B, the series power supply system 800 includes the above-mentioned detection circuit 810 for detecting the voltage difference between the two input terminals of the first to-be-powered circuit 112-1.

FIG. 8C is a schematic diagram of a series power supply system according to one embodiment of the disclosure. Compared with the embodiment shown in FIG. 8A, the two input terminals connected to the detection circuit 810 do not receive the voltage difference between the two input terminals of the same to-be-powered circuit 112-1. The two input terminals of the detection circuit 810 may be a first power terminal of one to-be-powered circuit 112 and a second power terminal of another to-be-powered circuit 112. When the voltage difference between the two input terminals is greater than a certain value, the detection circuit 810 outputs a signal to the switch port 431 of the protection circuit 430. When the switch port 431 receives an output signal indicating that the voltage difference exceeds a threshold value, the protection circuit 430 is turned on to prevent the series of the to-be-powered circuits 112 from burning. This connection can be applied to the embodiment of FIG. 8B.

FIG. 8D is a schematic diagram of a series power supply system according to one embodiment of the disclosure. Compared with the embodiment shown in FIG. 8C, the two input terminals connected to the detection circuit 810 may be the first power terminal of one to-be-powered circuit 112-2 and the second power terminal of another to-be-powered circuit 112-3 of the to-be-powered circuits 112. In other words, the present disclosure does not limit that the detection circuit 810 must be connected to the first to-be-powered circuit 112-1 in the to-be-powered circuits 112. This connection can also be applied to the embodiment of FIG. 8B.

FIG. 8E is a schematic diagram of a series power supply system according to one embodiment of the disclosure. This is a variation of the embodiment shown in FIG. 4C, and the description of the detection circuit 810 can be referred to FIG. 8A. In addition, those with ordinary skills in the related art can understand that the embodiment shown in FIG. 4C can also apply the variations of the embodiments shown in FIGS. 8B to 8D.

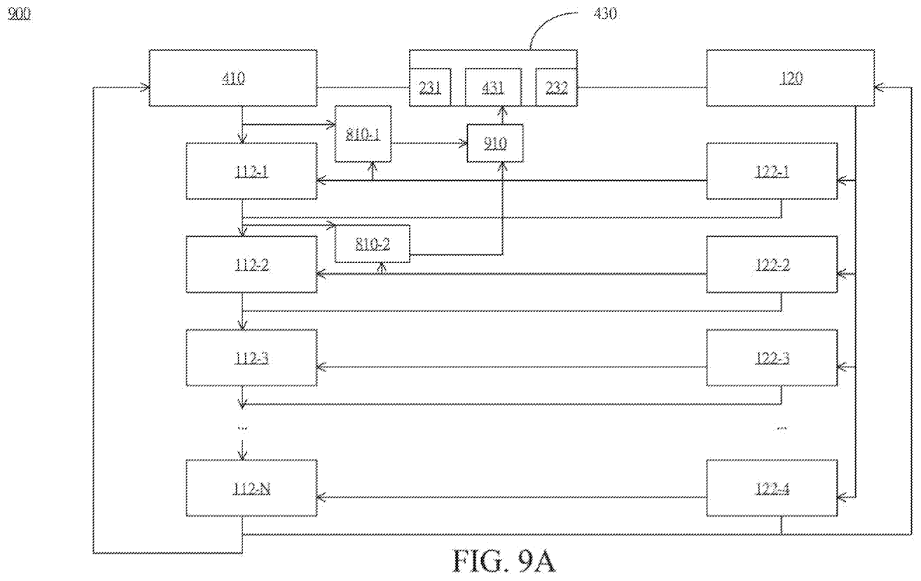

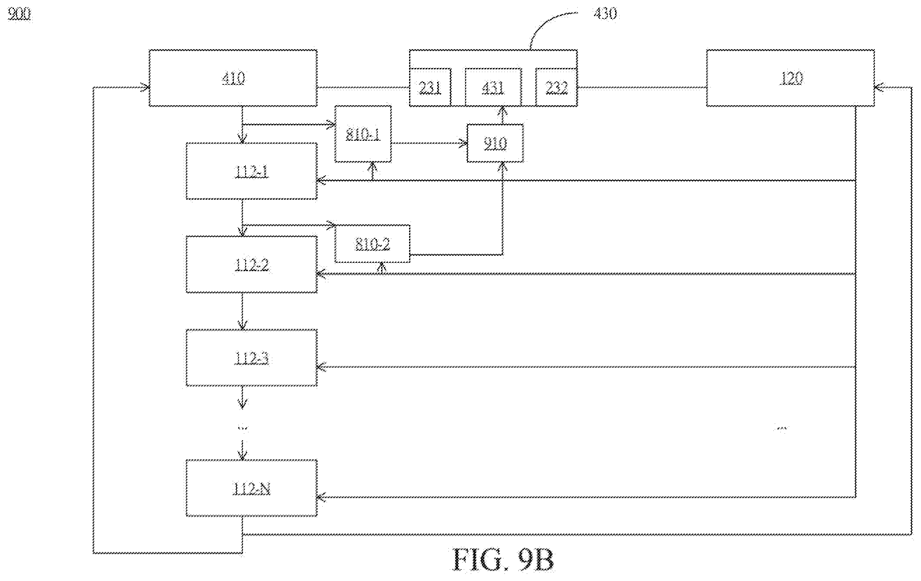

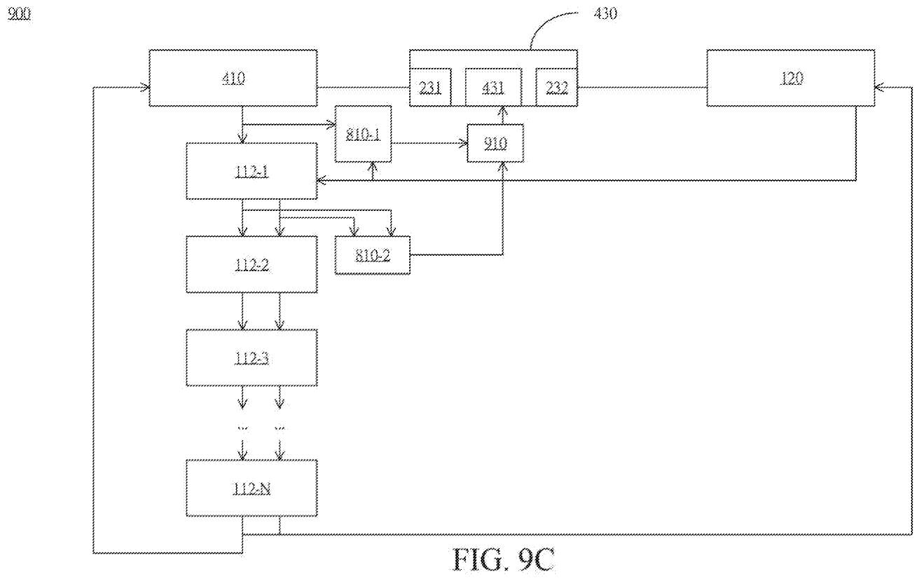

FIG. 9A is a schematic diagram of a series power supply system according to one embodiment of the disclosure. Compared with the embodiment shown in FIG. 8A to FIG. 8D, the embodiment shown in FIG. 9A includes two detection circuits 810-1 and 810-2. The two input terminals of the first detection circuit 810-1 are respectively the two power input terminals of the first to-be-powered circuit 112-1. The two input terminals of the second detection circuit 810-2 are respectively the two power input terminals of the second to-be-powered circuit 112-2. The outputs of the two detection circuits 810-1 and 810-2 are respectively connected to a logic circuit 910. The logic circuit 910 can output a signal to the switch port 431 of the protection circuit 430. When at least one of the two detection circuits 810-1 and 810-2 detects an abnormal condition, the protection circuit 430 would be activated by the signal output from the logic circuit 910 to the switch port 431.

Although in the embodiment shown in FIG. 9A, only two detection circuits 810 are depicted. However, those with ordinary skills in the related art can understand that the number of detection circuits 810 can be increased and the connection mode of the detection circuit 810 can be adjusted according to various embodiments and various variations of FIGS. 8A to 8D. The output of each detection circuit 810 is connected to the logic circuit 910, which may include various equivalent logic gates and their combination circuits. In one embodiment, the logic circuit 910 includes at least a NAND gate or a logic circuit equivalent to the NAND gate. When one of the input terminals of the logic circuit 910 receives a signal indicating an abnormal condition, the protection circuit 430 would be activated by the signal output by the logic circuit 910 to the switch port 431, so that the protection circuit 430 protects the to-be-powered circuits 112 connected in series. Only when all the input terminals of the multiple input terminals do not receive the abnormal condition signal, the protection circuit 430 would not be activated by the signal output from the logic circuit 910 to the switch port 431, so that the protection circuit 430 does not need to consume power to protect the to-be-powered circuits 112 connected in series.

FIG. 9B is a schematic diagram of a series power supply system according to one embodiment of the disclosure. Compared with the embodiment shown in FIG. 9A, the series power supply system 900 of FIG. 9B also includes a plurality of detection circuits 810 and a logic circuit 910. The remaining parts are similar to the embodiment shown in FIG. 4B.

FIG. 9C is a schematic diagram of a series power supply system according to one embodiment of the disclosure. Compared with the embodiment shown in FIG. 9A, the series power supply system 900 of FIG. 9C also includes a plurality of detection circuits 810 and a logic circuit 910. The remaining parts are similar to the embodiment shown in FIG. 4C.

In the above embodiments, the protection circuits 230, 430 and 630 are connected between the two power supplies. However, the protection circuit 230 can be used to protect one or more to-be-powered circuits 112 connected in series, that is, connect to one or more to-be-powered circuits 112 connected in series to be protected.

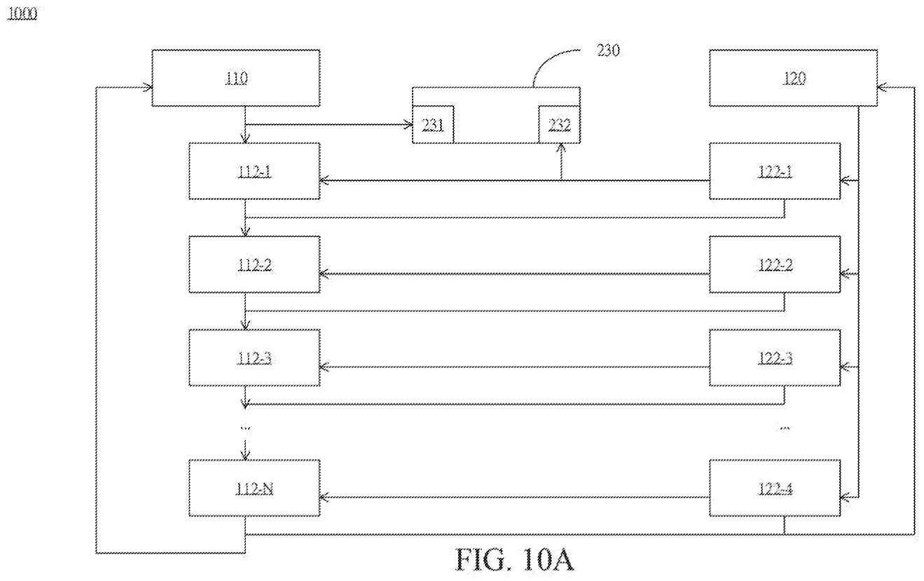

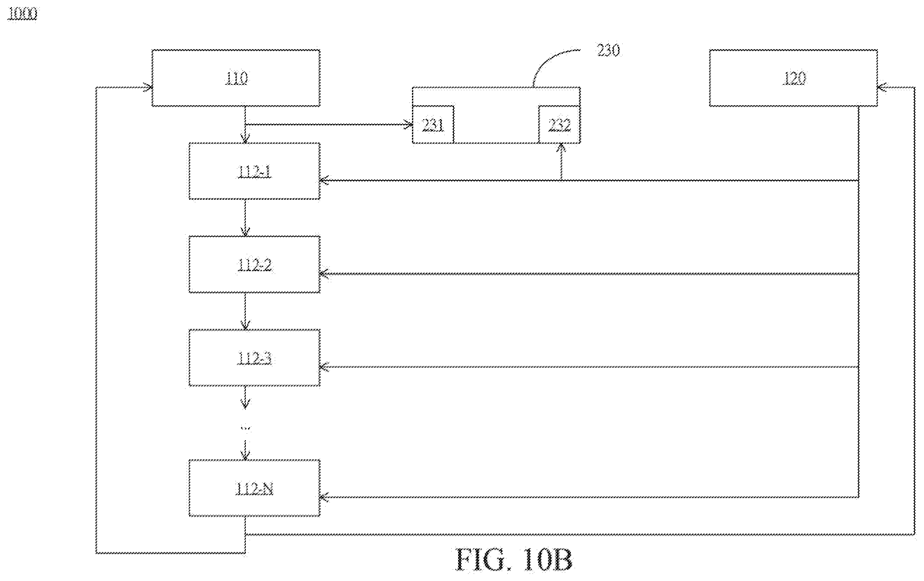

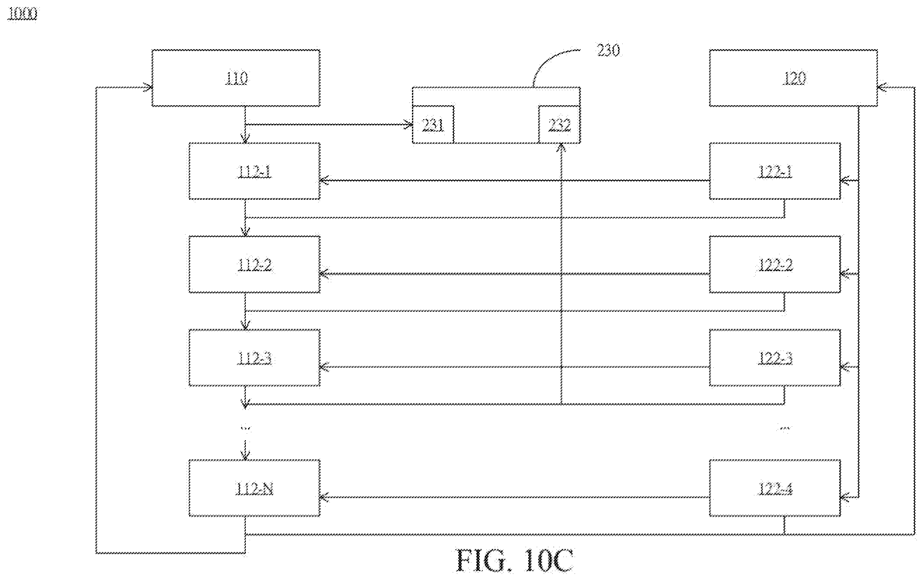

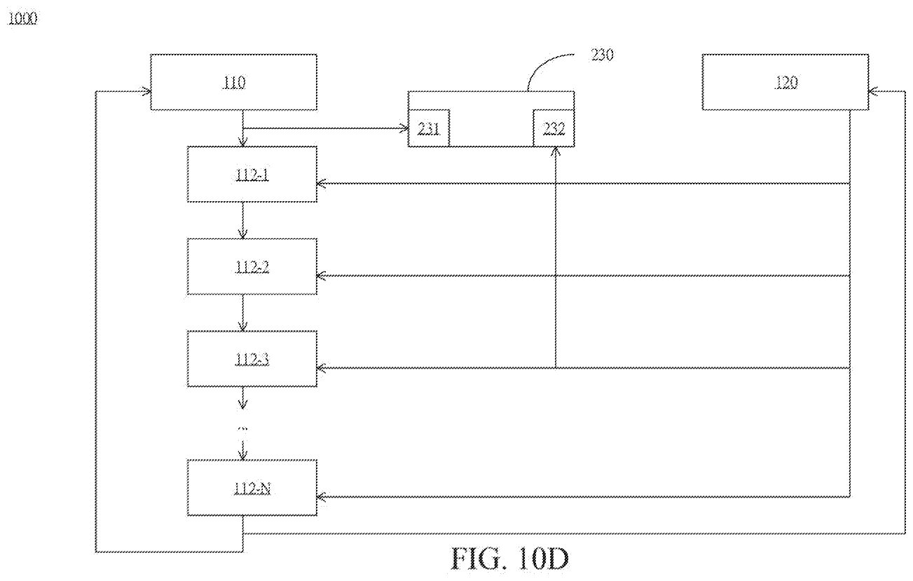

FIG. 10A is a schematic diagram of a series power supply system according to one embodiment of the disclosure. Compared with the embodiment shown in FIG. 1A, the embodiment shown in FIG. 10A includes a protection circuit 230. The first terminal 231 is connected to the first power input terminal of the to-be-powered circuit 112, and the second terminal 232 is connected to the second power input terminal of the same to-be-powered circuit 112. When the voltage difference between the first terminal 231 and the second terminal 232 exceeds a certain value, the protection circuit 230 starts protection.

FIG. 10B is a schematic diagram of a series power supply system according to one embodiment of the disclosure. Compared with the embodiment shown in FIG. 1B, the embodiment shown in FIG. 10B includes a protection circuit 230. The first terminal 231 is connected to the first power input terminal of the to-be-powered circuit 112, and the second terminal 232 is connected to the second power input terminal of the same to-be-powered circuit 112. When the voltage difference between the first terminal 231 and the second terminal 232 exceeds a certain value, the protection circuit 230 starts protection.

FIG. 10C is a schematic diagram of a series power supply system according to one embodiment of the disclosure. Compared with the embodiment shown in FIG. 10A, the first terminal 231 of the protection circuit 230 is connected to the first power input terminal of the first to-be-powered circuit 112-1, and the second terminal 232 is connected to the second power input terminal of the third to-be-powered circuit 112-3. When the voltage difference between the first terminal 231 and the second terminal 232 exceeds a certain value, the protection circuit 230 starts protecting the first to third to-be-powered circuits 112. In other words, the protection circuit 230 of the present disclosure can be used to protect a plurality of to-be-powered circuits 112 connected in series.

FIG. 10D is a schematic diagram of a series power supply system according to one embodiment of the disclosure. Compared with the embodiment shown in FIG. 10C, the second power input terminals of the plurality of to-be-powered circuits 112 are directly connected to the second power 120.

As shown in FIGS. 4A, 4B, 8A to 8D, 9A, and 9B, the embodiments shown in FIGS. 10A to 10D can incorporate a detection circuit 810 and change the protection circuit 230 to a protection circuit 430. When there are multiple detection circuits 810, a logic circuit 910 may be added between the detection circuits 810 and the switch port 431 of the protection circuit 430. When one of the input terminals of the logic circuit 910 receives a signal of an abnormal condition, the protection circuit 430 is activated by the signal output by the logic circuit 910 through the switch port 431, so that the protection circuit 430 protects the to-be-powered circuit 112 connected in series. Only when all the input terminals of the multiple input terminals do not receive the abnormal condition signal, the protection circuit 430 is not activated by the signal output by the logic circuit 910 through the switch port 431 so that the protection circuit 430 does not need to consume power to protect the to-be-powered circuit 112 connected in series.

According to one embodiment of the present disclosure, a series power supply system is provided. The series power supply system comprises a first DC power supply; a second DC power supply; a plurality of to-be-powered circuits connected to the first DC power supply in series, a first power for each of the to-be-powered circuits being supplied by the first DC power supply, a second power for each of the to-be-powered circuits being supplied by the second DC power supply; and a protection circuit respectively including a first terminal connected to the first DC power supply and a second terminal connected to the second DC power supply; wherein when the voltage difference between one or more of the to-be-powered circuits exceeds a threshold value, the protection circuit is used to protect the plurality of to-be-powered circuits from burning.

In the above embodiment, in order to provide a second power with more stable current and more accurate voltage, the series power supply system further includes a plurality of power supplies corresponding to the plurality of to-be-powered circuits, so as to respectively supply the second power to the to-be-powered circuits, wherein the second DC power supply supplies power to the plurality of power supplies.

In the above embodiment, in order to prevent the protection circuit from consuming too much power at ordinary times, the series power supply system further includes a first detection circuit to detect the output of the first DC power supply. When the first detection circuit detects that the output of the first DC power supply is abnormal, a first detection signal is output to the protection circuit for turning on the protection circuit to protect the plurality of to-be-powered circuits from burning. In the above embodiment, the protection circuit further includes a first electronic switch element connected to the first detection circuit, wherein the first electronic switch element turns on the protection circuit when receiving the first detection signal.

In the above embodiment, in order to prevent the protection circuit from consuming too much power at ordinary times, the series power supply system further includes a second detection circuit to detect the output of the second DC power supply. When the second detection circuit detects that the output of the second DC power supply is abnormal, a second detection signal is output to the protection circuit for turning on the protection circuit to protect the other power supplies burning. In the above embodiment, the protection circuit further includes a second electronic switch element connected to the second detection circuit, wherein the second electronic switch element turns on the protection circuit when receiving the second detection signal.

In the above embodiments, in order to prevent the protection circuit from consuming excessive power at ordinary times, the series power supply system further includes a third detection circuit to detect the voltage difference between the first power of the Xth to-be-powered circuit of the plurality of to-be-powered circuits and the second power of the Yth to-be-powered circuit of the plurality of to-be-powered circuits. When the third detection circuit detects that the voltage difference exceeds a critical value, the third detection circuit outputs a third detection signal to the protection circuit for turning on the protection circuit to protect the plurality of the to-be-powered circuits from burning, where X and Y are positive integers.

In the above embodiment, in order to prevent the protection circuit from consuming too much power at ordinary times, the series power supply system further includes a logic circuit and a plurality of fourth detection circuits. The logic circuit includes a plurality of input terminals and an output terminal. The output terminal is connected to the protection circuit. Each of the fourth detection circuits is used to detect the voltage difference between the first power and the second power of one or more of the plurality of to-be-powered circuits. When each of the fourth detection circuits detects that the voltage difference exceeds a critical value, a fourth detection signal is output to one of the plurality of input terminals of the logic circuit. When one of the input terminals receives the fourth detection signal, the logic circuit outputs a signal to the protection circuit for turning on the protection circuit to protect the plurality of to-be-powered circuits from burning.

In one embodiment of the present disclosure, a series power supply system is provided, comprising: a plurality of to-be-powered circuits connected to a first DC power supply in series, a first power for each of the to-be-powered circuits being supplied by the first DC power supply, a second power for each of the to-be-powered circuits being supplied by the second DC power supply; and a protection circuit comprising a first terminal and a second terminal, wherein the first terminal is connected to the first power of the Xth to-be-powered circuit, and the second terminal is connected to the second power of the Yth to-be-powered circuit; when the voltage difference between the first terminal and the second terminal exceeds a threshold value, the protection circuit is used to protect the plurality of to-be-powered circuits from burning; wherein X and Y are positive integers.

In the above embodiments, in order to provide a second power with a more stable current and a more accurate voltage, the second power of the plurality of to-be-powered circuits are respectively from a plurality of power supplies corresponding to the plurality of to-be-powered circuits, wherein the second DC power supply provides power to the plurality of the power supplies.

In the above embodiment, in order to provide different power modes with different voltage values for each to-be-powered circuit, the normal voltage value of the first power is different from the normal voltage value of the second power.

In the above embodiment, in order to reduce the circuit complexity and line width of the second power, the second power of each of the to-be-powered circuits are connected in series to the second DC power supply.

The series power supply system provided in the above embodiments includes a protection circuit, which can provide protection to the other to-be-powered circuits when one of the to-be-powered circuits connected in series suddenly fails, so as to prevent the other to-be-powered circuits from burning.

On the other hand, the power supply circuit of the existing mining machine uses a synchronous rectification voltage balance (BUCK) circuit to provide stable power for the chips. In the prior art, the power supply circuit provides power (output voltage) converted from a reference voltage through a synchronous rectification buck circuit to the chips connected in series. The internal resistance of each chip is not exactly the same. When the power (output voltage) is provided to the chips, the voltage provided for each chip is inconsistent because of the different internal resistance. In order to ensure the normal operation of all chips, the output voltage needs to be increased to ensure that the voltage of all chips can reach the normal working voltage. The greater the number of chips connected in series, the worse the voltage consistency across the chips. In order to ensure that all chips can work normally, the requirement of the higher output voltage result in the larger power consumption.

Furthermore, the large number of chips connected in series would have the problems such as high noise, voltage instability, overvoltage and burnout risk. Therefore, every chip must be configured with a BUCK circuit, and every two chips must be equipped with a monitoring unit. The monitoring unit monitors the voltage between every two chips. Then the voltage and the preset voltage are compared. The BUCK circuit is then controlled to adjust the voltage between the two chips according to the comparison result so that the adjusted voltage value is equal to the preset voltage value to ensure that all chips can normal work. However, this circuit design is very complex and costly. Further, each preset voltage value is also determined in advance and cannot be adjusted flexibly according to different power supplies, which is very limited in application.

In view of the above problems, the present disclosure further discloses a series power supply system for a multi-stage series circuit. The series power supply system disclosed in this application uses a dynamic voltage sensing unit to output a protection voltage according to a preset power voltage for a chip or a monitoring voltage of a chip, so that the dynamic voltage sensing unit can determine whether to activate the protection circuit or not according to the preset power voltage or the monitoring voltage. The problem of high noise, unstable voltage, overvoltage or risk of burnout arisen from the large number of chips connected in series may be solved.

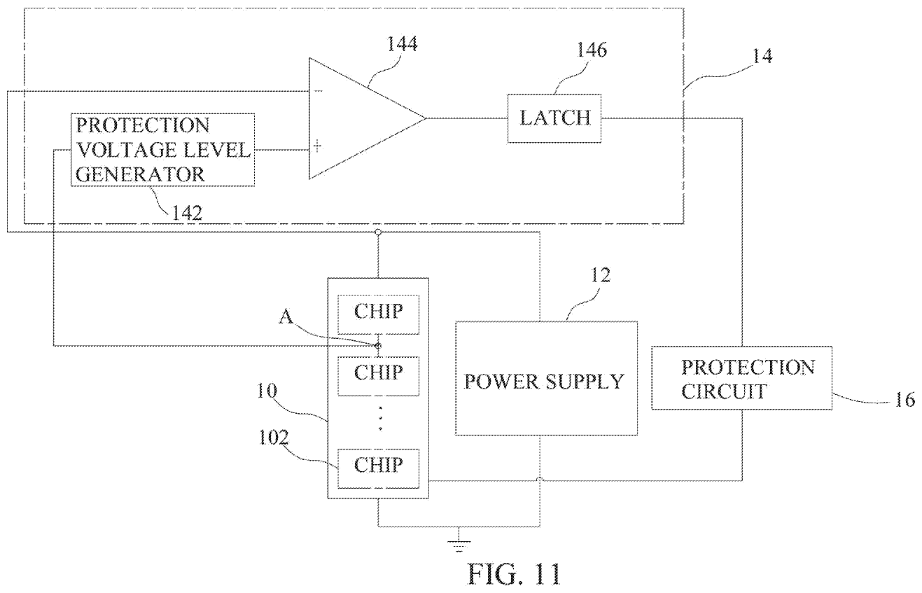

FIG. 11 is a circuit diagram of a power supply system for a multi-stage series circuit according to one embodiment of the present disclosure. The power supply system includes a power supply 12, a dynamic voltage sensing unit 14, and a protection circuit 16. The power supply 12 provides a power voltage to the multi-stage series circuit 10. The multi-stage series circuit 10 includes a plurality of chips 102 which are connected in series. In order to simplify the circuit drawing, the power supply 12 is electrically connected to both ends of the multi-level series circuit 10. In this example, a plurality of chips 102 are connected in series. The other way is that the power supply 12 provides a power voltage to each chip 102. In this example, an additional circuit must be configured. The power configuration of the two examples is well known to those of ordinary skills in the art and is not the technical problem to be solved by this application, so no further description is rendered.

The dynamic voltage sensing unit 14 includes a protection voltage level generator 142, a comparator 144, and a latch 146 configured optionally. That is, in one embodiment, the dynamic voltage sensing unit 14 includes a protection voltage level generator 142 and a comparator 144. In the other embodiment, the dynamic voltage sensing unit 14 includes a protection voltage level generator 142, a comparator 144, and a latch 146. To simplify the drawing, the two embodiments are drawn in the same drawing.

The protection voltage level generator 142 receives the reference voltage and generates a protection voltage according to the reference voltage. According to different embodiments, the reference voltage may be the monitoring voltage of the chip 102, or may be the preset power voltage provided by the system. According to the system design, different systems use different chip supply voltages, but each system has a preset power voltage for chips. The power supply 12 provides power to the chip 102 according to the preset power voltage, and the system also provides the preset power voltage to the protection voltage level generator 142 as a reference voltage through a control circuit or BIOS. The embodiment shown in FIG. 1 is to receive the monitoring voltage of the chip 102.

The comparator 144 includes a first input terminal and a second input terminal. For the convenience of explanation, the connection between the comparator 144 and other components uses a first input terminal and a second input terminal to represent a positive input terminal and a negative input terminal, respectively. In fact, the positive input terminal, the negative input terminal and the output terminal can be defined according to the actual design of the circuit, and are not limited to the definition and description. The first input terminal of the comparator 144 receives the protection voltage generated by the protection voltage level generator 142. The second input terminal is connected to the power supply 12 to receive the power voltage output by the power supply 12. In other words, the comparator 144 compares the protection voltage and the power voltage, and outputs the comparison voltage. In one embodiment, the protection circuit 16 is connected to the output of the comparator 144 and starts in response to the comparison voltage output by the comparator 144.

In another embodiment, since the voltage output by the comparator 144 is constantly changing, the latch 146 may be configured to maintain the comparison voltage output by the comparator 144. The output of the comparator 144 is connected to the latch 146. The comparator 144 compares the protection voltage with the power voltage and outputs the comparison voltage from the comparator 144 to the latch 146. The latch 146 is connected to the protection circuit 16. The latch 146 receives the comparison voltage to generate a starting voltage, and the protection circuit 16 starts in response to the starting voltage.

The power supply 12 provides a power voltage to the plurality of chips 102 connected in series. Due to manufacturing process factors, the internal resistance of each chip 102 has different internal resistance, boost, and buck states, so the voltage across each chip 102 does not necessarily remain the same during actual power supply. A monitoring point A is selected from the chips 102 connected in series to monitor the voltage of the chips 102 connected in series. The monitoring voltage of the chip 102 is used as a reference voltage of the protection voltage level generator 142. For example, the monitoring point A may be selected between the first chip 102 and the second chip 102. The monitoring point A is coupled to the input terminal of the protection voltage level generator 142, so that the protection voltage level generator 142 can receive the monitoring voltage of the monitoring point A, and then the protection voltage level generator 142 responds to the monitoring voltage to output the protection voltage to the comparator 144. The input terminal of the protection voltage level generator 142 receives the monitoring voltage via the monitoring point A. This monitoring point A can be selected according to the actual design of the circuit, so the monitoring point A between the first chip 102 and the second chip 102 is only an example, and in fact, the connection point between other chip can be selected as the monitoring point. Alternatively, more than one monitoring point can be selected to obtain the monitoring voltage of multiple monitoring points. In other embodiments, the protection voltage level generator 142 can also receive the monitoring voltage of the system. For example, the mining system is usually equipped with a control board having a circuit thereon to monitor the system voltage. Therefore, the reference voltage required by the protection voltage level generator 142 can also come from the control board. Alternatively, the preset power voltage for the chip may be stored in the system chip on the control board. Therefore, the reference voltage required by the protection voltage level generator 142 can use the preset power voltage stored in the system chip on the system board instead of the monitoring voltage.

The first input terminal of the comparator 144 receives the protection voltage output by the protection voltage level generator 142, and the second input terminal of the comparator 144 receives the monitoring voltage or the preset chip power voltage. The comparator 144 compares the protection voltage and the monitoring voltage, or compares the protection voltage and the preset chip power voltage. After the comparison by the comparator 144, the output terminal of the comparator 144 outputs the comparison voltage. For example, when the comparison voltage output by the comparator 144 is a high-level voltage signal, it can be defined as that the monitoring voltage of the chip 102 is abnormal; otherwise, when the comparison voltage output by the comparator 144 is a low-level voltage signal, it can be defined as that the chip 102 is operating in normal voltage state. Therefore, the protection circuit 16 is activated according to the comparison signal. In the embodiment configured with the latch 146, the latch 146 receives the comparison signal, and accordingly generates the starting voltage. For example, when the latch 146 receives the comparison signal as a high voltage level, a starting voltage for driving the protection circuit 16 is generated, and the protection circuit 16 starts in response to the starting voltage.

After the protection circuit 16 is started, the protection circuit 16 can dynamically adjust the power voltage received by the chip 102. For example, the protection circuit 16 may adjust the power voltage by stepping down the power voltage for the chip.

The chip 102 is a certain chip in the series circuit 10, or a plurality of chips, or all chips, and the number of chips can be selected according to actual circuit requirements. For example, from experience if the second chip 102 is easily burned due to overvoltage, the protection circuit 16 dynamically adjusts the power voltage of the second chip 102 when the protection circuit is started. Therefore, in the figure, the protection circuit 16 is connected to one end of the series circuit 10, that is, the first chip 102, which is only an exemplary representation. The second chip 102 used for explanation here is for the selection of the monitoring point A. In other words, the chip most likely to be burnt can be selected as the monitoring point, and the protection circuit 16 performs dynamic voltage adjustment for the selected chip.

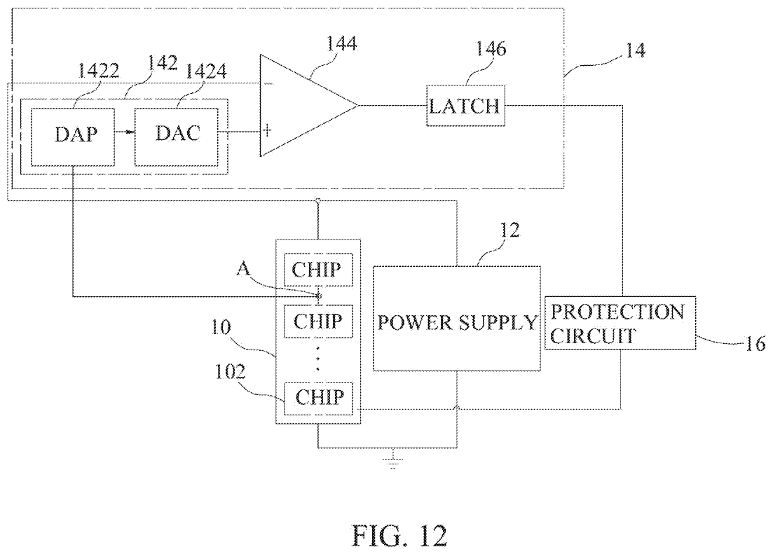

FIG. 12 is a circuit diagram of a power supply system for a multi-stage series circuit according to another embodiment of the present disclosure. The embodiment shown in the figure uses a monitoring voltage. The elements in the embodiment of FIG. 12 that are the same as the embodiment of FIG. 11 use the same reference numerals, and the same parts are not described again. The protection voltage level generator 142 is a digital circuit including a digital signal processor (DSP) 1422 and a digital to analog converter (DAC) 1424. The digital signal processor 1422 is connected to a digital to analog converter 1424 and the digital to analog converter 1424 is connected to the input terminal of the comparator 144. In this embodiment, the preset power voltage of the system is used as the reference voltage for the protection voltage level generator 142. Therefore, the digital signal processor 1422 is configured with a built-in comparison table for the protection voltage level. The comparison table for the protection voltage level lists the corresponding values between the preset power voltages and the protection voltages, that is, each preset power voltage has a corresponding protection voltage. The protection voltage level generator 142 may look up the corresponding protection voltage using the comparison table according to the preset power voltage. In particular, the digital to analog converter 1424 receives the reference voltage and outputs a digital reference voltage according to the reference voltage based on the comparison table. Then the digital to analog converter 1424 performs the digital to analog conversion on the digital reference voltage to convert the digital reference voltage as a protection voltage.

In another embodiment, the protection voltage level generator 142 can also use the monitoring voltage. The embodiment shown in the figure uses a monitoring voltage. The digital to signal processor 1422 is electrically connected to the multi-stage series circuit 10. The input terminal of the protection voltage level generator 142 is connected to the monitoring point A of the chip 102. The voltage at the monitoring point A is generated as a monitoring voltage. The input terminal of the protection voltage level generator 142 receives the monitoring voltage. In other words, when the digital signal processor 1422 receives the monitoring voltage, the digital signal processor 1422 looks up the corresponding digital protection voltage according to the monitoring voltage. The digital protection voltage is then transmitted to the digital to analog converter 1424, which converts the digital protection voltage to an analog protection voltage and outputs the analog protection voltage to the first input terminal of the comparator 144. Therefore, the built-in comparison table for the protection voltage level is the corresponding relationship between the monitoring voltage and the protection voltage.

The first input terminal of the comparator 144 receives the protection voltage, and the second input terminal of the comparator 144 receives the power voltage. The comparator 144 compares the protection voltage and the power voltage and then outputs the comparison voltage. When the comparison voltage is at a high voltage level, that is, when the chip 102 is in an overvoltage state, the protection circuit 16 is activated in response to the comparison voltage having the high voltage level. In the embodiment where the latch 146 is configured, the latch 146 receives the comparison voltage and accordingly generates the starting voltage. When the latch 146 receives the starting voltage having a high voltage level, that is, when the chip 102 is in an overvoltage state, a starting voltage for driving the protection circuit 16 is generated, and the protection circuit 16 starts in response to the starting voltage.

In the embodiment of the second FIG. 12, in order to avoid the occurrence of burn-out of the chips 102 connected in series due to over-voltage, the protection circuit 16 is activated in response to the comparison voltage output by the comparator 144 or the starting voltage output by the latch 146 such that the protection circuit 16 may perform the corresponding protection mechanism, for example, change the power voltage for the chip. With the digital monitoring and the dynamic adjustment for the protection voltage, not only is it fast, but it can be very accurately adjusted to the working voltage range required by multiple chips 102 connected in series. This solution has practicality and application flexibility for practical circuit operation. It can indeed solve many problems such as high noise, unstable voltage, over-voltage or risk of easy burnout arisen from the large number of chips connected in series.

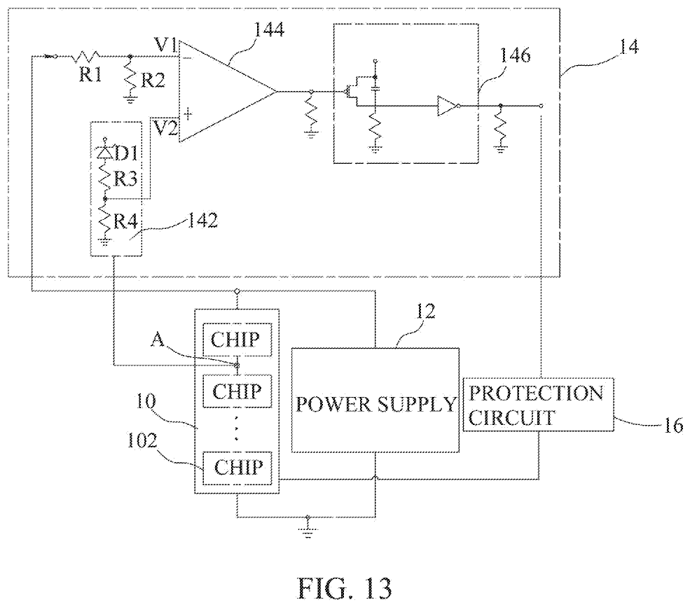

FIG. 13 is a circuit diagram of a power supply system for a multi-stage series circuit according to another embodiment of the present disclosure. The elements in the embodiment of FIG. 13 and the embodiment of FIG. 11 have the same reference numerals, and the same parts are not described again. The difference between the embodiment of FIG. 13 and the embodiment of FIG. 11 is that the protection voltage level generator 142 is an analog circuit. The protection voltage level generator 142 includes a diode D1, a first resistor R3 and a second resistor R4. The embodiment shown in the figure is in series, but certainly parallel connection can also be used. In terms of the actual operation of the circuit, the protection voltage level generator 142 outputs the protection voltage according to the monitoring voltage at the monitoring point A. The power voltage provided by the power supply 12 is divided by the resistor R1 and the resistor R2 such that the output voltage V1 is generated. The monitoring voltage on the Nth chip 102 is greater than the breakdown voltage of the diode D1. This breakdown voltage is designed according to the monitoring voltage. After the diode D1 is turned on, the current flows through the first resistor R3 and the second resistor R4. The voltage is then divided by the resistor R1 and the resistor R2 to output the protection voltage V2. In this embodiment, the diode D1 can be a Zener diode D1.

The comparator receives and compares the power voltage V1 and the protection voltage V2. When the protection voltage V2 is greater than the power voltage V1, the comparison voltage at the high voltage level is output. On the contrary, when the protection voltage V2 is less than the power voltage V1, the comparison voltage at the low voltage level is output. Similar to the foregoing embodiments, the comparator outputs the comparison voltage to the protection circuit 16 after the comparison. When the comparator outputs a comparison voltage at a high voltage level, it indicates that there is an overvoltage for the multiple chips 102, that is, there is a risk of burning out for the multiple chips 102. In the meanwhile, the protection circuit 16 starts in response to the starting voltage. In the embodiment configured with the latch 146, the latch 146 generates a corresponding starting voltage according to the received comparison voltage having the high voltage level or the low voltage level. That is to say, the comparison voltage having the high voltage level means that there are overvoltages for the multiple chips 102, that is, there is a risk of burning out for the multiple chips 102. In the meanwhile, the protection circuit 16 is activated in response to the starting voltage to perform a protection mechanism such as adjusting the power voltage for the chip. By way of such manner, the plurality of chips 102 connected in series can be protected to operate within the normal operating voltage range.

In the embodiment where the protection voltage level generator 142 is an analog circuit, a precise calculation is necessary to avoid the occurrence of a voltage matrix. That is the monitoring poring A at the Nth chip 102 is selected for the monitoring voltage. The position of the monitoring poring A depends on the possibility of covering all chips 102. In one case, if there are too many chips 102, more than two dynamic voltage sensing units 14 may be provided in the circuit to correspond to more than two sets of monitoring voltages. In this way, all the chips 102 can be covered. Although analog circuits must be calculated accurately to avoid the occurrence of a voltage matrix, the relative operation speed is fast, and the circuit manufacturing cost can be greatly reduced.

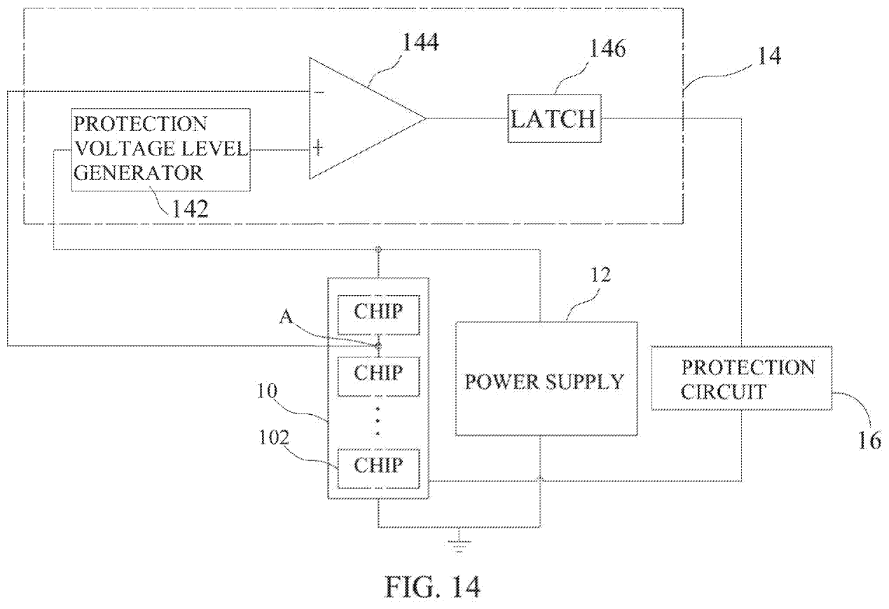

FIG. 14 is a circuit diagram of a power supply system for a multi-stage series circuit according to another embodiment of the present disclosure. The elements in the embodiment of FIG. 14 and the embodiment of FIG. 11 have the same reference numerals. In this embodiment, the power supply system includes a power supply 12, a dynamic voltage sensing unit 14 and a protection circuit 16. The dynamic voltage sensing unit 14 includes a protection voltage level generator 142, a comparator 144, and a latch 146 configured optionally. That is, in one embodiment, the dynamic voltage sensing unit 14 includes a protection voltage level generator 142 and a comparator 144. In another embodiment, the dynamic voltage sensing unit 14 includes a protection voltage level generator 142, a comparator 144, and latch 146. To simplify the drawing, the two embodiments are drawn in the same drawing. In addition to supplying the power voltage to the multi-stage series circuit 10, the power supply 12 also supplies the power voltage to the dynamic voltage sensing unit 14. That is, the power voltage is provided to the protection voltage level generator 142 as a reference voltage. The protection voltage level generator 142 receives the reference voltage and generates a protection voltage according to the reference voltage. The protection voltage level generator 142 is configured with a built-in comparison table for the protection voltage level. The comparison table for the protection voltage level lists the corresponding values between the power voltages and the protection voltages, that is, each power voltage has a corresponding protection voltage. The protection voltage level generator 142 may look up the corresponding protection voltage using the comparison table according to the power voltage. The first input terminal of the comparator 144 receives the protection voltage generated by the protection voltage level generator 142. The second input terminal is connected to the multi-stage series circuit 10 for receiving the monitoring voltage of the monitoring point A. The comparator 144 compares the protection voltage and the monitoring voltage, and outputs the comparison voltage. The protection circuit 16 is connected to the output terminal of the comparator 144 and starts in response to the comparison voltage output by the comparator 144.

In another embodiment, since the voltage output by the comparator 144 is constantly changing, the latch 146 may be configured to maintain the comparison voltage output by the comparator 144. The output of the comparator 144 is connected to the latch 146. The comparator 144 compares the protection voltage with the monitoring voltage and outputs the comparison voltage from the comparator 144 to the latch 146. The latch 146 is connected to the protection circuit 16.

Similar to the first embodiment, for example, when the comparison voltage output by the comparator 144 is a high voltage level signal, it can be defined that the monitoring voltage of the serial chip 102 is abnormal. On the contrary, when the comparison voltage output by the comparator 144 is a low voltage level signal, it can be defined that the chip 102 is operating in a normal state. Then in one embodiment, the protection circuit 16 activates in response to the comparison voltage with the high voltage level. In the embodiment configured with the latch 146, the latch 146 receives the comparison voltage and generates the starting voltage accordingly. For example, when the latch 146 receives the comparison voltage at a high voltage level, a starting voltage for driving the protection circuit 16 is generated, and the protection circuit 16 starts in response to the starting voltage.

According to another aspect of the embodiments of the present disclosure, a mining machine is provided, including a chassis, a control board located inside the chassis, an expansion board connected to the control board, and a computing board, having the series power supply system of the above embodiments, connected to the expansion board.

In summary, the power supply system for a multi-stage series circuit disclosed in the present disclosure outputs a protection voltage according to the preset power voltage of the chips or the monitoring voltage of the chips through the dynamic voltage sensing unit, so that the dynamic voltage sensing unit may determine whether to activate the protection circuit according to the power voltage of the chips or the monitoring voltage of the chips. The problem of high noise, voltage instability, overvoltage and easy burnout arisen from the many chips connected in series may be solved. In addition, in the prior art, the chips are additionally configured with a voltage balancing unit or a circuit required to maintain the voltage level balance. The series power supply system disclosed in this application does not need to configure these additional circuits, and can reduce the design cost and complexity of the circuit.

It is to be understood that the term “comprises”, “comprising”, or any other variants thereof is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the present disclosure. Accordingly, such modifications are considered within the scope of the present disclosure as limited solely by the appended claims.

What is claimed is:

1. A series power supply system, comprising:
a first DC power supply;
a second DC power supply;
a plurality of to-be-powered circuits connected to the first DC power supply in series, a first power for each of the to-be-powered circuits being supplied by the first DC power supply, a second power for each of the to-be-powered circuits being supplied by the second DC power supply; and
a protection circuit respectively including a first terminal connected to the first DC power supply and a second terminal connected to the second DC power supply; wherein when the voltage difference between one or more of the to-be-powered circuits exceeds a threshold value, the protection circuit protects the plurality of to-be-powered circuits from burning.

2. The series power supply system according to claim 1, further comprises a plurality of power supplies corresponding to the to-be-powered circuits, the plurality of power supplies providing the second power of the to-be-powered circuits, wherein the second DC power supply provided power to the plurality of power supplies.

3. The series power supply system according to claim 1, further comprises a first detection circuit for detecting the output of the first DC power supply, when the first detection circuit detects that the output of the first DC power supply is abnormal, the first detection circuit outputs a first detection signal to the protection circuit for turning on the protection circuit to protect the plurality of to-be-powered circuits from burning.

4. The series power supply system according to claim 3, wherein the protection circuit further comprises a first electronic switch element connected to the first detection circuit, wherein when the first detection signal is received, the first electronic switch element turns on the protection circuit.

5. The series power supply system according to claim 2, further comprises a second detection circuit for detecting the output of the second DC power supply, when the second detection detects circuit that the output of the second DC power supply is abnormal, the second detection circuit outputs a second detection signal to the protection circuit for turning on the protection circuit to protect the other power supplies from burning.

6. The series power supply system according to claim 5, wherein the protection circuit further comprises a second electronic switch element connected to the second detection circuit, wherein when the second detection signal is received, the second electronic switch element turns on the protection circuit.

7. The series power supply system according to claim 1, further comprises a third detection circuit for detecting the voltage difference between the first power of the Xth to-be-powered circuit of the plurality to-be-powered circuits and the second power of the Yth to-be-powered circuit of the plurality to-be-powered circuits, when the third detection circuit detects that the voltage difference is greater than a threshold, the third detection circuit outputs a third detection signal to the protection circuit for turning on the protection circuit to protect the plurality of to-be-powered circuits from burning, wherein X and Y are positive integers.

8. The series power supply system according to claim 1, further comprises:
a logic circuit, having a plurality of input terminals and an output terminal, the output terminal being connected to the protection circuit; and
a plurality of fourth circuits, each of the fourth circuits detecting the voltage difference between the first power of one or more of the to-be-powered circuits and the second power of one or more of the to-be-powered circuits, when each of the fourth detection circuits detects that the voltage difference is greater than a threshold, the fourth detection circuit outputs a fourth detection signal to one of the plurality of input terminals of the logic circuit;
wherein when one of the plurality of input terminals of the logic circuit receives the fourth detection circuit, the logic circuit outputs a signal to the protection circuit for turning on the protection circuit to protect the plurality of to-be-powered circuits from burning.

9. The series power supply system according to claim 1, wherein the normal voltage of the first power is different from the normal voltage of the second power.

10. The series power supply system according to claim 1, wherein the second power of each of the to-be-powered circuits connects to the second DC power supply in series.

11. A series power supply system, comprising:
a plurality of to-be-powered circuits connected to a first DC power supply in series, a first power for each of the to-be-powered circuits being supplied by the first DC power supply, a second power for each of the to-be-powered circuits being supplied by a second DC power supply; and
a protection circuit comprising a first terminal and a second terminal, wherein the first terminal is connected to the first power of the Xth to-be-powered circuit, and the second terminal is connected to the second power of the Yth to-be-powered circuit; when the voltage difference between the first terminal and the second terminal exceeds a threshold value, the protection circuit protects the plurality of to-be-powered circuits from burning; wherein X and Y are positive integers.

12. The series power supply system according to claim 9, wherein the second powers of the to-be-powered circuits are respectively from the plurality of the power supplies corresponding to the to-be-powered circuits, wherein the second DC power supply provides power to the plurality of power supplies.

13. The series power supply system according to claim 11, wherein the normal voltage of the first power is different from the normal voltage of the second power.

14. The series power supply system according to claim 11, wherein the second power of each of the to-be-powered circuits connects to the second DC power supply in series.
